(19) United States
(12) Patent Application Publication
(10) Pub. No.: US 2024/0106882 A1
(43) Pub. Date: Mar. 28, 2024

(54) METHODS AND SYSTEMS FOR PACKAGING AND SENDING CONTENT

(71) Applicant: COMCAST CABLE COMMUNICATIONS, LLC, Philadelphia, PA (US)

(72) Inventors: Jeffrey Sheldon, Philadelphia, PA (US); Bryan Taft, Philadelphia, PA (US); Neill Kipp, Philadelphia, PA (US)

(21) Appl. No.: 17/951,761

(22) Filed: Sep. 23, 2022

(51) Int. Cl. H04L 65/75

(52) U.S. Cl. CPC H04L 65/75; H04N 7/0117

(57) ABSTRACT

A computing device may receive, in a communication session, a request for a first portion of content (e.g., video, audio, audio/video, web-based content, games, applications, data, etc.) at a first representation. The first representation may be associated with a first video resolution. The computing device may send the first portion of the content to the user device at the first representation. The computing device may receive, in the communication session, a second request for a second portion of the content at a second representation. The second representation may be associated with a second video resolution that is different from the first video resolution. The computing device may send, in the communication session, the second portion of the content to the user device at the second representation.

### BACKGROUND

Content (e.g., video, audio, games, websites, applications, data) may be provided to users in a variety of ways. For example, content may be provided or offered to users in multiple different video representations and/or audio representations. Each video representation may be associated with different video resolutions (e.g., screen resolution) and/or bitrates. Each audio representation may be associated with different audio resolutions, bitrates, CODECs and/or compression rates.

Most conventional systems divide each representation into multiple segments or portions of the representation of the content, each being containered in its own file. These systems then store all of the files for all of the representations of each content item at multiple networking levels, so that networking devices and user devices may access the files associated with the representation of the content item that is requested or can be processed by the user device. This results in a large number of individual files being stored at multiple network levels for each content item.

### SUMMARY

It is to be understood that both the following general description and the following detailed description are exemplary and explanatory only and are not restrictive. Methods and systems for packaging and sending content are described.

Content may be more efficiently stored and managed by creating files that each contain a segment or portion of content in multiple different representations. The files may be sent to a networking device proximate to user devices for access by the user devices. A user device may request the content in a communication session and may receive different representations of the content in the same communication session.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for the packaging and distribution of content to a user device;

FIG. 2 shows an example file format for the distribution of content;

FIG. 3 shows a flowchart of an example method for sending content at different representations to a user device;

FIG. 4 shows a flowchart of an example method for sending content at different representations to the user device;

FIG. 5 shows a flowchart of an example method for packaging content in a file comprising a plurality of representations of the content;

FIG. 6 shows a flowchart of an example method for receiving content at different representations;

FIG. 7 shows a flowchart of an example method for receiving content at different representations;

FIG. 8 shows a flowchart of an example method for packaging content in a file comprising a plurality of representations of the content;

FIG. 9 shows a flowchart of an example method for packaging content in a file comprising a plurality of representations of the content; and

FIG. 10 shows a block diagram of a computing device for implementing the packaging and distribution of content.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG-2, MPEG, MPEG-4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio.

This detailed description may refer to a given entity performing some action. It should be understood that this language may in some cases mean that a system (e.g., a computer) owned and/or controlled by the given entity is actually performing the action.

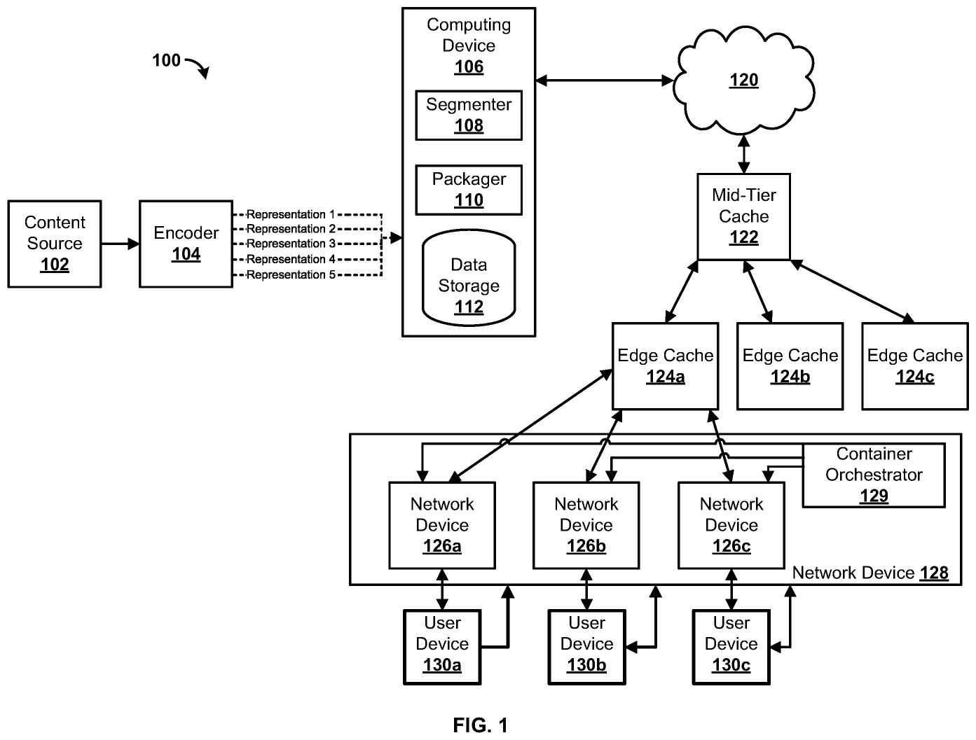

Methods and systems are described herein for packaging and sending content. FIG. 1 shows an example system 100. The example system 100 may be configured for the packaging and distribution of content (e.g., video content, audio content, audio/video content, web-based content, games, applications, data, streaming content, movies, shows/programs, etc.). Although only certain devices and/or components are shown, the system 100 may comprise a variety of other devices and/or components that support a wide variety of network and/or communication functions, operations, protocols, content, services, and/or the like. The system 100 may comprise a plurality of computing devices/entities in communication via a network 120. The network 120 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 120 via a variety of transmission paths, including wireless paths (e.g., satellite paths, Wi-Fi paths, cellular paths, etc.) and terrestrial paths (e.g., wired paths, a direct feed source via a direct line, etc.). The network 120 may comprise public networks, private networks, wide area networks (e.g., Internet), local area networks, and/or the like. The network 120 comprise a content access network, content distribution network, and/or the like. The network 120 may be configured to provide content from a variety of sources using a variety of network paths, protocols, devices, and/or the like. The content delivery network and/or content access network may be managed (e.g., deployed, serviced) by, for example, a content provider, a service provider, and/or the like. The network 120 may deliver content (e.g., content items) from a content source 102 to one or more other computing devices (e.g., user devices 130a-c).

The system 100 may comprise the one or more content sources 102, each of which may be a server or other computing device. The content source 102 may receive source streams for a plurality of content which may comprises a plurality of content items. The source streams may be video content, audio content, web-based content, audio/video content, games, applications, data, etc. The source streams may be live streams (e.g., a linear content stream) audio-on-demand streams, video-on-demand (VOD) streams, web data, application data, or the like. The content source 102 may receive source streams from an external server or device (e.g., a stream capture source, a data storage device, a media server, etc.). The content source 102 may receive the source streams via a wired or a wireless network connection, such as the network 120 or another network (not shown). For example, the content source 102 may be a multicast or a unicast content source configured to send or otherwise transmit content via a multicast or unicast transmission.

The content source 102 may be managed by a third-party, such as content providers, service providers, online content providers, over-the-top content providers, and/or the like. The content source 102 may be configured to provide content (e.g., content items) via the network 124. Content may be accessed by one or more user devices 130a-c via applications, such as mobile applications, television applications, set-top box applications, gaming device applications, web-based applications, and/or the like. An application may be a custom application (e.g., by a content provider, for a specific device), a general content browser (e.g., a web browser), an electronic program guide, and/or the like.

Although one content source 102 is shown in FIG. 1, this is not to be considered limiting. In accordance with the described techniques, the system 100 may comprise any number of content sources, each of which may receive and provide any number of source streams.

The system 100 may comprise one or more encoders 104, such as a video encoder, an audio encoder a content encoder, etc. The encoder 104 may be configured to encode content (e.g., received via the content source 102 or another computing device) into a plurality of representations of the content (e.g., video representations, audio representations, audio/video representations, etc.). For example, the encoder 104 may be configured to encode the content at varying video representations associated with varying video resolutions and/or bitrates and/or varying audio representations associated with varying audio resolutions, bitrates, CODECs, and/or compression settings for corresponding representations (e.g., versions, such as Representations 1-5) of the content (e.g., the content items) for adaptive bitrate streaming. It is to be understood that FIG. 1 shows five representations for explanation purposes only, as the encoder 104 may be configured to encode the source stream into fewer or greater representations.

The system 100 may comprise a computing device 106. The computing device 106 may be configured to receive encoded content (e.g., one or more of the encoded content items/encoded content streams) from the encoder or any other computing device at the various representations (e.g., a plurality of video representations, a plurality of audio representations, a plurality of audio/video representations, etc.). While the example of FIG. 1 shows the encoder 104 being separate from the computing device 106, in other examples, the encoder 104 or a portion of the encoders 104 (in a system comprising a plurality of encoders) may be part of the computing device 106. The computing device may comprise a packager 110. The packager 110 may be configured to prepare content (e.g., content items/content streams) for distribution. For example, the packager 110 may be configured to convert the various representations of the encoded content (e.g., encoded content items/encoded content streams) into a plurality of portions or segments of the content for each of the representations of the content. For example, the packager 110 may comprise a segmenter 108. The computing device 106 may also comprise (or have access to) a data storage device 112. The data storage device 112 may be a component of the computing device 106, as shown in FIG. 1, or it may be a separate device/entity within the system 100 (e.g., a cache device, data storage repository, database, etc.) in communication with the computing device 106. For example, the data storage device 112 may be a part of or comprise one or more of an origin server or a content server.

The segmenter 108 may divide encoded content into media/content portions or segments. For example, the segmenter 108 may process the incoming encoded representations of the content and break the encoded representations of the content into portions or segments at key frame boundaries at or near particular time periods (e.g., two-second time periods) apart or data allotments. For example, the segmenter 108 may receive a target portion or segment duration, such as a quantity of milliseconds, seconds, minutes, etc. The target segment duration may be determined via a configuration file at the computing device 106 and/or determined based on properties of the associated content. For example, if the target portion or segment duration is two seconds, the segmenter 108 may segment (e.g., separate, divide, etc.) the encoded content at the particular representation into a plurality of portions or segments of the content at the particular representation. For example, the portions or segments of the content may comprise a set duration, such as two seconds or about two seconds, depending on a format of the portions or segments of the content.

Further, if the encoded content includes separate video representations of the content and audio representations of the content, the segmenter 108 may generate the portions or segments of the particular audio and video representations of the content such that the portions or segments of the video representation of the content and the audio representation of the content are timecode aligned. Segments may alternately be referred to as “portions” or “chunks.”

The packager 110 may be configured to support both multiplexed portions or segments (video and audio data included in a single multiplexed version of the content) and non-multiplexed segments (video and audio data included in separate non-multiplexed versions of the content). Further, in the case of MPEG-DASH, the packager 110 may be configured to support container formats in compliance with international standards organization base media file format (ISOBMFF), associated with a file extension “.m4s”), motion picture experts group 2 transport stream (MPEG-TS), extensible binary markup language (EBML), WebM, Matroska, or any combination thereof.

The packager 110 may be configured to provide content (e.g., content items/content streams) according to adaptive bitrate streaming. For example, the packager 110 may be configured to convert encoded content at various representations into one or more adaptive bitrate streaming formats, such as Apple HTTP Live Streaming (HLS), Microsoft Smooth Streaming, Adobe HTTP Dynamic Streaming (HDS), MPEG DASH, and/or the like. The packager 110 may pre-package content and/or provide packaging in real-time as content is requested by user devices, such as the user devices 130a-c.

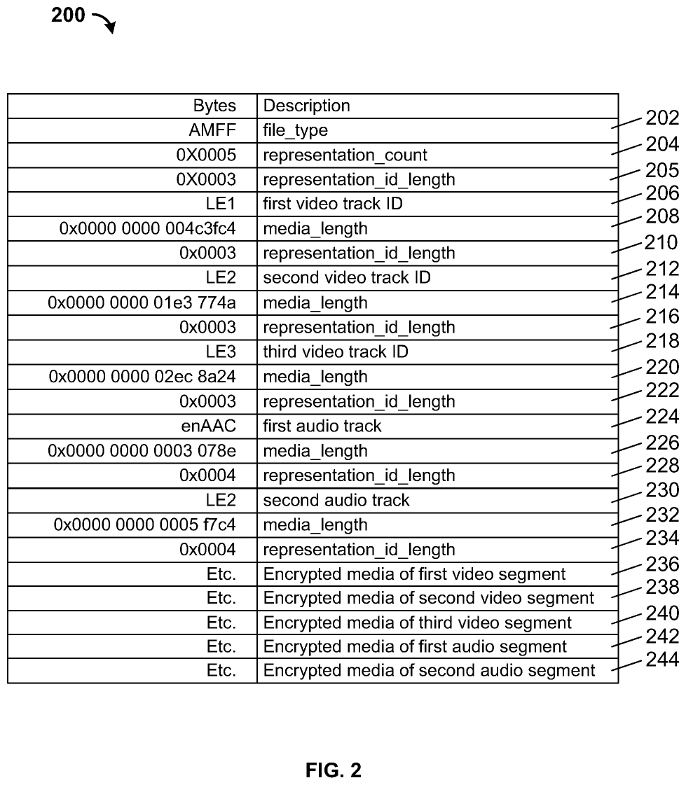

The system 100 may comprise one or more mid-tier caches 122. Each mid-tier cache 122 may comprise a server and/or storage device (e.g., a data storage repository, database, etc.) for storing content (e.g. portions or segments of the content at various representations). While the example of FIG. 1 shows one mid-tier cache 122, this is for example purposes only, as the system 100 can comprise a plurality of mid-tier caches 122. The mid-tier cache 122 may be configured to receive portions or segments of the content (e.g., for multiple content items/content streams) from the computing device 106 and/or the data storage device 112 via the network 120 or another network. The mid-tier cache 122 may be configured to store the received portions or segments of the content in a storage device included with or associated with the mid-tier cache 122. For example, the mid-tier cache 122 may be configured to store a file comprising a portion of the content encoded in multiple representations (e.g., multiple video representations, multiple audio representations, or a combination thereof). For example, the file may be formatted according to an aggregate media file format (AMFF). An AMFF file may comprise a header, such as the header 200 as described below in FIG. 2. The header may indicate the number of representations of the portion or segment of the content included in the file, the run length of each representation of the portion or the segment included in the file, and an indication of the bitrate associated with the representation of the portion or the segment included in the file. The AMFF file may also comprise multiple representations of a portion or segment of content (e.g., portion or segment of a content item or content stream) in a single file.

The mid-tier cache 122 may be configured to send or transmit one or more portions or segments of the content (e.g., as part of the AMFF file) to one or more edge devices (e.g., edge caches 124a-c). For example, an edge cache 124a-c (e.g., edge cache 124a) may be positioned geographically closer to the user devices 130a-c than the mid-tier cache 122.

The system 100 may comprise one or more edge caches 124a-c. Each edge cache 124a-c may comprise a server and/or storage device (e.g., a data storage repository, database, etc.) for storing content (e.g. portions or segments of the content at various representations). While the example of FIG. 1 shows three edge caches 124a-c, this is for example purposes only, as the system 100 can comprise a plurality of edge caches 124a-c greatly in excess of the three shown.

The edge cache 124a-c may be configured to receive portions or segments of the content (e.g., for multiple content items/content streams) from the mid-tier cache 122 and/or the data storage device 112 via the network 120 or another network. The edge cache 124a-c may be configured to store the received portions or segments of the content in a storage device included with or associated with each edge cache 124a-c. For example, the edge cache 124a-c may be configured to store the plurality of AMFF files, each comprising a portion of the content encoded in multiple representations (e.g., multiple video representations, multiple audio representations, or a combination thereof).

The edge caches 124a-c may be configured to provide (directly or indirectly) content, services, and/or the like to user devices 130a-c. Each edge cache 124a-c may be located in a region proximate (e.g., local) to the location of the user devices 130a-c associated with the particular edge cache 124a-c. For example, a request for content from the user device 130a may be directed to the edge cache 124a (e.g., due to the location of the edge cache 124a, the distance of the edge cache 124a to the user device 130a being shorting than the distance from the user device 130a to other edge caches, and/or network conditions). The edge cache 124a may evaluate the request to determine the content being requested and/or the user device 130a-c making the request. The edge cache 124a may then forward the request to the network device 128 for further processing of the request. In another example, the request may initially come to the network device 128 rather than the edge cache 124a.

The system 100 may comprise one or more network devices 128. The network device 128 may comprise a container orchestrator 129. For example, the network device 128 (e.g., the container orchestrator 129) may be configured to provision, instantiate, deploy, assign, network, and/or manage one or more network devices (e.g., network devices 126a-c) to interact with one or more user devices 130a-c. For example, the network device 128 (e.g., the container orchestrator 129) may provision, instantiate, deploy, assign, network, and/or manage one or more network device 126a-c to interact with a respective one of the user devices 130a-c during a communication session.

For example, the network device 128 may receive a request for content. The request for content may be received directly from the particular user device 130a-c or indirectly from the particular user device 130a-c via a corresponding edge cache (e.g., edge cache 124a). The network device 128 may evaluate the request for content to determine one or more of the user device 130a-c making the request and the content (e.g., content item, stream, web content, game, application, data, etc.) being requested.

For example, if a network device 126a-c is not available, the container orchestrator 129 or another portion of the network device 128 may instantiate or create a network device (e.g., network device 126a) to handle the request from the user device 130a and communicate with the user device 130a via a communication session. For example, if the network device 126a is already created and available, the container orchestrator 129 or another portion of the network device 128 may assign the network device 126a to handle the request from the user device 130a and communicate with the user device via a communication session. While the example of FIG. 1 shows one network device 128, this is for example purposes only, as the system 100 can comprise a plurality of network devices 128. Each network device 128 may be associated with a single edge device 124a-c (e.g., network device 128 associated with edge device 124a as shown in FIG. 1) or may be associated with more than one edge device 124a-c.

The system 100 may comprise one or more network devices 126a-c. For example, each network device 126a-c may comprise a node, such as a filtering relay node. The network devices 126a-c may be configured to communicate with one or more edge caches via the network 120 or another network. Each network device 126a-c may be configured to communicate with a corresponding user device 130a-c via the network 120 or another network.

For example, the network device 126a-c may be configured to receive a request for content directly or indirectly (e.g., via the edge cache 124a-c and/or network device 128) from the user device 130a-c. For example, the network device 126a-c may be created or instantiated by the network device 128 (e.g., the container orchestrator 129) and/or assigned by container orchestrator 129 or another portion of the network device 128 to handle the request and receive the request from the user device 130a-c. The network device 126a-c may be configured to initiate a communication session with the user device 130a-c based on, for example, receiving or being assigned the request for the content from the user device 130a-c. The network device 126a-c may be configured to evaluate the request for content to determine the content being requested based on, for example, a content identifier in the request. The network device 126a-c may be configured to evaluate the request for content to determine, the portion or segment of the content being requested based on, for example, a segment identifier in the request. The network device 126a-c may be configured to request the portion or segment of the content from the associated edge cache 124a-c.

For example, the network device 126a-c may be configured to receive portions or segments of the content (e.g., for multiple content items/content streams) from the corresponding or associated edge cache 124a-c via the network 120 or another network. The network device 126a-c may be configured to store the received portions or segments of the content in a storage device included with or associated with each network device 126a-c. For example, the network device 124a-c may be configured to receive and store a plurality of AMFF files, each comprising a portion of the content encoded in multiple representations (e.g., multiple video representations, multiple audio representations, or a combination thereof). For example, the network device 124a-c may be configured to store all of the segments of a content item for a plurality of content items at one or multiple different representations in the plurality of AMFF files.

For example, the network device 126a-c may be configured to send or transmit content to a corresponding user device 130a-c during the communication session initiated between the particular network device 126a-c and the particular user device 130a-c. For example, the user device 130a-c may request each portion or segment of the content from the network device 126a-c at different representations (e.g., different video representations and/or different audio representations) during the single communication session and may receive the different portions of the content, at the different representations, from the network device 126a-c. For example a single or same communication session may comprise the particular network device 126a-c and the particular user device 130a-c beginning the communication session and not disconnecting from one another or terminating the communication session while or between the particular user device 130a-c receiving the different representations of the content from the particular network device 126a-c. For example, the single or same communication session may comprise the particular network device 126a-c maintaining a socket connection with the particular user device 130a-c at the particular user device 130a-c and/or the particular user device 130a-c maintaining another socket connection with the particular network device 126a-c at the particular network device 126a-c while or between the particular user device 130a-c receiving the different representations of the content from the particular network device 126a-c.

For example, the network device 126a may receive a request for a first portion of the content at a first representation (e.g., a first video representation) from the user device 130a during the communication session. The network device 126a may identify the file comprising the first portion of the content received from the edge cache 124a and comprising multiple representations of the first portion of the content. The network device 126a may determine the requested representation of the first portion of the content and may copy or extract that representation of the first portion of the content from the file. The network device 126a may generate a second file comprising the first portion of the content at the requested representation. For example, the second file may be an MPEG-2 transport stream (TS) file, an MPEG-4 basic media file format (BMFF) file, or another file format. For example, the second file may only include the portion of the content in a single representation (e.g., the requested representation). The network device 126a may send or transmit the second file to the user device 130a via the network 120 or another network during the communication session.

For example, the network device 126a may receive a request for a second portion of the content at a second representation (e.g., a second video representation different from the first video representation) from the user device 130a during the communication session. The network device 126a may identify the file comprising the second portion of the content received from the edge cache 124a and comprising multiple representations of the second portion of the content. The network device 126a may determine the requested second representation of the second portion of the content and may copy or extract that second representation of the second portion of the content from the file. The network device 126a may generate a third file comprising the second portion of the content at the requested second representation. For example, the third file may be a TS file, a BMFF file, or another file format. For example, the third file may only include the portion of the content in a single representation (e.g., the requested second representation). The network device 126a may send or transmit the third file to the user device 130a via the network 120 or another network during the communication session.

Conventional user devices do not maintain a communication session with the network device when requesting multiple representations of the content (e.g., video content, audio content, and audio-video content) as the load on the network devices managing the great number of possible user devices would degrade performance.

However, the user device 130a may, for example, maintain the same communication session with the network device 126a while receiving both the first portion of the content at the first representation and the second portion of the content at the second representation. For example, the network device 128 may create, instantiate, or assign a single network device 126a-c for handling the communication session with each particular user device 130a-c that makes a request. For example, the network devices 126a-c may be or comprise a filtering relay node. For example, the network device 126a-c (e.g., the filtering relay node) may be a virtual node or networking device and may provide a one-to-one communication path with the particular user device 130a-c for which it was created or to which it was assigned. By, for example, creating or assigning the network devices 126a-c as they are needed (e.g., based on the number of user devices 130a-c making requests) and providing the one-to-one communication path between a particular user device 130a-c and a particular network device 126a-c the communication session between the network device (e.g., the network device 126a and the particular user device (e.g., the user device 130a) may be maintained for as long as the user device 130a is requesting the content, even if it includes requesting different representations of the content during the communication session. For example, the connection between the network device 126a and the user device 130a may be maintained throughout the communication session by the user device 130a and/or the network device 126a.

For example, as part of the initial request by the user device 130a for the first portion of the content at the first representation, a socket connection is made at the network device 126a for the user device 130a. In response to the initial request, the network device 126a may make a socket connection at the user device 130a. For example, after the initial request from the user device 130a, subsequent requests for the content by the user device 130a, no matter the representation being requested, may be received by the network device 126a at the already established socket connection at the network device 126a. For example, the network device 126a may then send the content associated with those requests at the already established socket connection at the user device 130a. For example, the user device 130a may maintain the connection with the network device 126a by maintaining the socket connection at the network device 126a. Furthermore, the network device 126a may maintain the connection with the user device 130a by maintaining the socket connection at the user device 130a.

By maintaining the communication session between the user device 130a and the network device 126a through multiple request for the content at, for example, multiple representations, efficiency of the communication session is improved, as the user device 130a only needs to negotiate a connection with the network device 126a one time and does not have to be delayed in reestablishing a connection with the network device 126a or another network device due to a busy or overloaded network and/or, for example, quality of service rules.

Furthermore, by providing each of the content segments of a content item in multiple representations in an edge cache 124a-c positioned locally with respect to the particular user device 130a-c, the network device 126a-c has a shorter route, through fewer devices, to obtain the content requested by the particular user device 130a-c, which results in a shorter round trip time from request by the user device 130a-c to receipt by the user device 130a-c of the requested content and further reduces or eliminates the impact of failure, latency issues, or bandwidth issues of devices upstream from the edge cache 124a-c on the edge cache 124a-c itself since it already has local access to portions of the content items in multiple representations.

At the completion of the communication session (e.g., once the user device 130a-c has received all the portions of the content that it has requested, the communication session may be terminated and the network device 126a-c may be deleted or reassigned to another user device 130a-c for another communication session.

While the example above describes the first and second representations being different video representations, this is for example purposes only. In other examples, the first and second representations may be different audio representations. The network device 126a-c may also be configured to send to the user device 130a-c, based on the request for the content, a manifest file (e.g., or other index file) describing the portions or segments of the content and the available representations (e.g., video representations and/or audio representations) for each portion or segment of the content.

The system 100 may comprise one or more user devices 130a-c. For example, the user device may comprises one or more of a client device, a personal computer, computing station, workstation, portable computer, laptop computer, mobile phone, tablet device, smartphone, smartwatch, activity tracker, smart apparel, smart accessory, security and/or monitoring device, a mobile device, a game system, a content output device, an IoT device, or the like. Each user device 130a-c may be configured to determine, generate and/or send requests for content. For example, the requests may be sent from one of the user devices 130a-c to the edge cache 124a, the network device 138, and/or a particular network device 126a-c via the network 120 or another network. For example, each network device 126a-c may be associated with a corresponding one of the user devices 130a-c for a communication session involving the request for the content. The user device 130a-c may be configured to receive portions or segments of the content from the network device 126a-c during the communication session. The portions or segments of the content may be in the same or different representations (e.g., different video representations and/or different audio representations). The user device 130a-c may be configured to display the received portions or segments of the content on a display of or associated with the user device 130a-c.

FIG. 2 is an example file format for a file used for the distribution of content (e.g., the transmission or sending or portions or segments of the content). For example, the file may be configured to contain multiple video and/or audio representations for a portion or segment of the content and may be configured to be sent from a computing device (e.g., the computing device 106) to one or more other computing devices (e.g., the caches 122, 124a-c and the network device 126a-c) in the network 100. For example, the file format may be an aggregate media file format (AMFF).

The file may comprise a header 200. The header 200 of the file may comprise an indicator of the file type 202. For example, the header 200 of the file indicates that the file type 202 is an AMFF file. The header 200 of the file may comprise an indicator of the number of representations 204 of the portion of the content being provided in the file. For example, the header 200 indicates the number of representations 204 of the portion of the content in the example file is five representations of the portion of the content. The header 200 of the file may comprise an indicator of the portion of the content 205 being provided in the file. For example, the header 200 indicates the portion of the content is the third portion of the content. The header 200 of the file may comprise an identifier of the particular representations 206, 212, 218, 224, 230 of the portion of the content being provided in the file. For example, the header 200 of the file identifies three video representations LE1 206, LE2 212, and LE3 218, and two audio representations enAAC 224, and LE2 230 of the portion of the content are being provided in the file. For example, each of the video representations being provided in the file may be associated with a different video resolution and/or different bitrate. For example, each of the audio representations being provided in the file may be associated with a different audio resolution and/or bitrate.

For example, the header 200 of the file may comprise an indication of the bitrate or video resolution 208, 214, 220, or the bitrate or audio resolution 226, 232 of the corresponding video representations LE1 206, LE2 212, and LE3 218, and audio representations enAAC 224, and LE2 230 of the portion of the content being provided in the file. The header 200 of the file may comprise an indication of the run length 210, 216, 222, 228, 234 for each representation of the portion of the content in the file. The file may also include the data 236-244 (e.g., bytes) for each representation of the portion of the content item in the file. For example, the data 236-244 may comprise multiple copies of the same portion of the content (or video portion of the same portion of the content) at different video resolutions and/or bitrates. For example, the data 236-244 may comprise multiple copies of the same portion of the content (or audio portion of the same portion of the content) at different audio resolutions and/or bitrates.

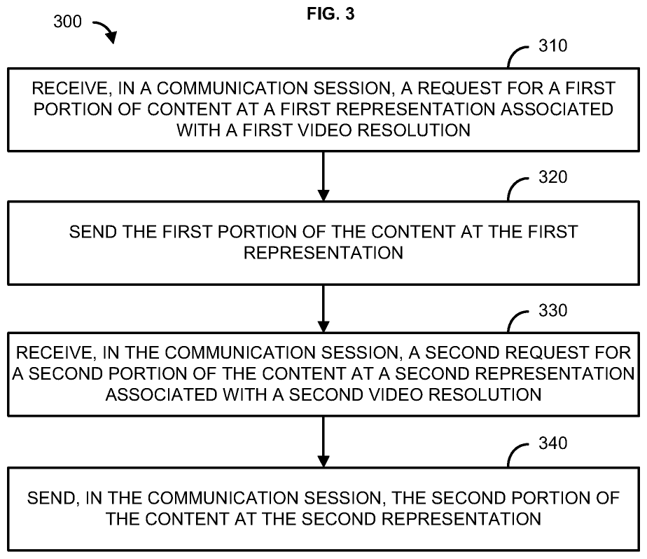

FIG. 3 is a flowchart of an example method 300 for sending content at different representations to a device requesting the content. The methods described in FIG. 3 may be completed by a computing device (e.g., the network devices 126a-c, the edge caches 124a-c, or any other computing device described herein). While the example of FIG. 3 will describe method 300 being completed by the network device 126a, this is for example purposes only, as all or any other portion of the method 300 may be completed by any other computing device described herein.

The requested content may be, for example, video content, audio content, audio/video content, web-based content, games, applications, data, streaming content, movies, shows/programs, etc. For example, the representations may be associated with video resolution, audio resolution, a combination of video and audio resolution, bitrate, coder-decoder setting (CODECs), and/or compression settings. For example, each representation may indicate a requested video resolution (e.g., screen resolution/bitrate) at which the requesting device wants to receive the content. For example, each representation may indicate the requested video resolution/bitrate at which the requesting device will most efficiently receive or process the content. For example, the video resolution may be any one or more of 480p, 576p, 720p, 1080p, 1440p, 4K, or 8K. For example, the requested video resolution may be associated with (e.g., sent at or intended to be sent at) a particular bitrate.

For example, each representation may indicate a requested audio resolution (e.g., CODEC, bitrate, compression setting, or the like) at which the requesting device wants to receive the content. For example, each representation may indicate the requested audio resolution at which the requesting device will most efficiently receive the content. For example, the audio resolution may be any one or more of MP3, WAV, advanced audio coding (AAC), Ogg Vorbis, Apple's lossless audio codec (ALAC), free lossless audio codec (FLAC), audio interchange file format (AIFF), direct stream digital (DSD), pulse-code modulation (PCM) or master quality authenticated (MQA). For example, the requested audio resolution may be associated with (e.g., sent at or intended to be sent at) a particular bitrate.

A computing device (e.g., the edge caches 124a-c) may receive a plurality of files related to one or more items of the content. For example, the edge caches 124a-c may receive the plurality of files from another computing device (e.g., the mid-tier cache 122) via a network. The mid-tier cache 122 may receive the plurality of files from yet another computing device (e.g., the computing device 106) via the network 120. While the example describes the mid-tier cache 122 receiving the plurality of files from the computing device 106, in other examples, one or more additional tiers or cache devices may be between the mid-tier cache 122 and the computing device 106 and/or between the mid-tier cache 122 and the edge caches 124a-c. For example, the computing device 106, the mid-tier cache 122 and the edge caches 124a-c may store copies of the plurality of files of the content item in associated storage devices.

For example, each file of the plurality of files may include a portion of a particular content item. For example, the particular content item may comprise a television show, a movie, a sporting event, a concert, a game, streaming content, an application, data, etc.). For example, the portion of the particular content item may be a segment of the content. For example, a plurality of segments (e.g., portions) may together make up the content item. For example, each segment may comprise or be associated with an amount of time or data of the content item. For example, each segment may comprise about two seconds of the content item. In other examples, each segment may comprise more or less than two seconds of the content item or a particular amount of data of the content item.

Each file of the plurality of files of the content item may comprise multiple representations of the particular portion of the content item. For example, each file may comprise representations associated with multiple video resolutions and/or multiple audio resolutions for the portion of the content item. For example, each file of the plurality of files may be an aggregate media file format (AMFF) file.

For example, each file may comprise a header (e.g., header 200 of FIG. 2). The header 200 of the file may indicate 204 the number of representations of the portion of the content item. The header 200 of the file may also comprise an identifier of the particular representation 206, 212, 218, 224, 230. For example, the header 200 of the file identifies three video representations 206, 212, 218, and two audio representations 224, 230 with the file for the portion of the content item. For example, the header 200 of the file may comprise an indication of the bitrate or resolution 208, 214, 220, 226, 232 of each representation in the file. The header 200 of the file may comprise an indication of the run length 210, 216, 222, 228, 234 for each representation in the file. The file may also include the data 236-244 (e.g., bytes) for each representation of the portion of the content item in the file.

At 310, a request may be received for a portion of the content. For example, the portion of the content may comprise the first portion of the content. For example, the request may be received from a user device (e.g., the user device 130a). For example, the request may be received by a network device (e.g., the edge cache 124a, the network device 128, or the network device 126a). For example, the network device 126a may receive the request directly from the user device 130a or indirectly via the edge cache 124a and/or the network device 128. For example, the network device 128 may comprise a container orchestrator 129. For example, the request for the content may comprise a user device identifier that identifies the user device 130a, the content identifier that identifies the content being requested, an identifier of the first portion or segment of the content requested, a first requested video representation (e.g., video resolution/bitrate), and/or a first requested audio representation (e.g., audio resolution or compression rate). While the example references the request being for the first portion of the content, this is for example purposes only as the request may be for any portion of the content and the reference to first is not intended to be limited to the actual first portion of the content.

The edge cache 124a and/or the network device 128 may evaluate the request and determine another network device (e.g., network device 126a) to associate with the user device 130a. For example, the edge cache 124a and/or the network device 128 may determine the network device 126a based on one or more of the identifier of the content being requested, the identifier of the user device, the first requested video representation, or the first requested audio representation. For example, the network device 128 (e.g., the container orchestrator 129) may instantiate or create the network device 126a. For example, the network device 126a may be created or instantiated by the container orchestrator 129 or another portion of the network device 128 based on the request from the user device 130a. The network device 128, may relay or send the request received from the user device 130a to the network device 126a. For example, the network device 126a may comprise one or more (e.g., a plurality of) nodes, such as one or more (e.g., a plurality of) filtering relay nodes.

The network device 126a may receive the request from the container orchestrator 129 or another portion of the network device 128. In another example, the network device 126a may receive the request directly from the user device 130a. The network device 126a may initiate a communication session with the user device 130a via a network. The communication session may comprise a wired communication session, a wireless communication session, or a combination thereof. The communication session between the network device 126a and the user device 130a may be a direct communication session or an indirect communication, with one or more additional nodes or network devices making up the communication path between the user device 130a and the network device 126a.

The network device 126a may evaluate the request. For example, the network device 126a may determine, based on the evaluation of the request, the identifier of the content being requested and the first portion of the content being requested. The network device 126a may send a request for the first portion of the content to an edge cache associated with the user device 130a and/or the network device 126a (e.g., the edge cache 124a). The request from the network device 126a may comprise one or more of the user device identifier, the content identifier, and the identifier of the first portion or segment of the content being requested. For example, the request may comprise a request for the AMFF file for the first portion or segment of the content.

The edge cache 124a may receive the request for the first portion of the content from the network device 126a. The edge cache 124a may evaluate the request to determine a file of the plurality of files of the content that corresponds to or is associated with the first portion or segment of the content being requested. For example, the edge cache 124a may determine the file based on the content identifier and/or the identifier of the first portion or segment of the content being requested in the request from the network device 126a. The determined file comprising the first portion of the content being requested may comprise multiple representations of the first portion of the content. For example, the file may comprise multiple representations of the first portion of the content that are each associated with a different one of the multiple video resolutions of the first portion of the content. For example, the file may comprise two or more representations of the portion of the content, each associated with a different video resolution of the first portion of the content item.

The edge cache 124a may send the file comprising the first portion of the content being requested to the network device 126a. The network device 126a may receive the file comprising the first portion of the content being requested and store the file in memory.

The network device 126a may evaluate the request received from the user device 130a to determine the first requested video representation (e.g., video resolution/bitrate). The network device 126a may, based on the first requested video representation, identify or determine the representation of the first portion of the content associated with the first requested video representation in the file of the first portion of the content. For example, the representation of the first portion of the content may be associated with the first requested video representation when the representation of the first portion of the content has a video representation (e.g., resolution or bitrate) that matches or corresponds to the first requested video representation.

The network device 126a may copy, extract, or remove the bytes associated with the determined representation of the first portion of the content associated with the first requested video representation from the file of the first portion of the content. The network device 126a may repackage the copied, extracted, or removed bytes comprising the first requested video representation of the portion of the content into a second file to be sent to the user device 130a. For example, the second file may be one of an MPEG-2 transport stream (TS) or an MPEG-4 base media file format (BMFF) or another file format. For example, the second file may only include a single video representation (e.g., the first requested video representation) of the first portion of the content.

At 320, the first portion of the content at the first video representation may be sent. For example, the requested first portion of the content at the requested first video representation may be sent by the network device 126a to the user device 130a (e.g., the requesting device). For example, the requested first portion of the content at the requested first video representation may be sent in the second file (e.g., a TS or BMFF file). For example, the requested first portion of the content at the requested first video representation may be sent via the communication session. For example, the communication session between the network device 126a and the user device 130a may remain active between the time the user device 130a makes the request for the first portion of the content and the time the network device 126a sends the first portion of the content to the user device 130a. The user device 130a, may receive the first portion of the content and display and or store the first portion of the content. For example, network device 126a may cause the first portion of the content to be displayed at the first requested video representation on the user device 130a by sending the first portion of the content to the user device 130a.

At 330, a second request for a second portion of the content may be received. For example, the second request may be received by the network device 126a from the user device 130a. For example, the second request for the second portion of the content may comprise a user device identifier that identifies the user device 130a, the content identifier that identifies the content being requested, an identifier of the second portion or segment of the content requested, a second requested video representation (e.g., video resolution/bitrate), and/or a second requested audio representation (e.g., audio resolution or compression rate). For example, the second requested video representation is different than the first requested video representation.

For example, the second request may be received via the communication session. For example, the communication session between the network device 126a and the user device 130a may remain active or be maintained between the time the user device 130a makes the request for the first portion of the content at the first video representation and the time the network device 126a receives the second request for the second portion of the content at the second video representation. For example, as part of the initial request by the user device 130a for the first portion of the content at the first representation, a socket connection is made at the network device 126a for the user device 130a. In response to the initial request, the network device 126a may make a socket connection at the user device 130a. For example, after the initial request from the user device 130a, subsequent requests for the content by the user device 130a, no matter the representation being requested, may be received by the network device 126a at the already established socket connection at the network device 126a. For example, the network device 126a may then send the content associated with those requests at the already established socket connection at the user device 130a. For example, the user device 130a may maintain the connection with the network device 126a throughout the communication session by maintaining the socket connection at the network device 126a. Furthermore, the network device 126a may maintain the connection with the user device 130a throughout the communication session by maintaining the socket connection at the user device 130a.

By maintaining the communication session between the user device 130a and the network device 126a through multiple request for the content at, for example, multiple representations, efficiency of the communication session is improved, as the user device 130a only needs to negotiate a connection with the network device 126a one time and does not have to be delayed in reestablishing a connection with the network device 126a or another network device due to a busy or overloaded network and/or, for example, quality of service rules.

While the example references the request being for the second portion of the content, this is for example purposes only as the request may be for any portion of the content and the reference to second is not intended to be limited to a particular portion of the content.

The network device 126a may evaluate the second request. For example, the network device 126a may determine, based on the evaluation of the second request, the identifier of the content being requested and the second portion of the content being requested. The network device 126a may send a request for the second portion of the content to the edge cache 124a. The request from the network device 126a may comprise one or more of the user device identifier, the content identifier, and the identifier of the second portion or segment of the content being requested. For example, the request may comprise a request for the AMFF file for the second portion or segment of the content.

The edge cache 124a may receive the request for the second portion of the content from the network device 126a. The edge cache 124a may evaluate the request to determine a file of the plurality of files of the content that corresponds to or is associated with the second portion or segment of the content being requested. For example, the edge cache 124a may determine the file based on the content identifier and/or the identifier of the second portion or segment of the content being requested in the request from the network device 126a. The determined file comprising the second portion of the content being requested may comprise multiple representations of the second portion of the content. For example, the file may comprise multiple representations of the second portion of the content that are each associated with a different one of the multiple video resolutions of the second portion of the content. For example, the file may comprise two or more representations of the second portion of the content, each associated with a different video resolution of the second portion of the content item.

The edge cache 124a may send the file comprising the second portion of the content being requested to the network device 126a. The network device 126a may receive the file comprising the second portion of the content being requested and store the file in memory.

The network device 126a may evaluate the second request received from the user device 130a to determine the second requested video representation (e.g., video resolution/bitrate). The network device 126a may, based on the second requested video representation, identify or determine the representation of the second portion of the content associated with the second requested video representation in the file of the second portion of the content. For example, the representation of the second portion of the content may be associated with the second requested video representation when the representation of the second portion of the content has a video representation (e.g., resolution or bitrate) that matches or corresponds to the second requested video representation.

The network device 126a may copy, extract, or remove the bytes associated with the determined representation of the second portion of the content associated with the second requested video representation from the file of the second portion of the content. The network device 126a may repackage the copied, extracted, or removed bytes comprising the second requested video representation of the second portion of the content into a third file to be sent to the user device 130a. For example, the third file may be one of the TS file or the BMFF file or another file format. For example, the third file may only include a single video representation (e.g., the second requested video representation different from the first requested video representation) of the second portion of the content.

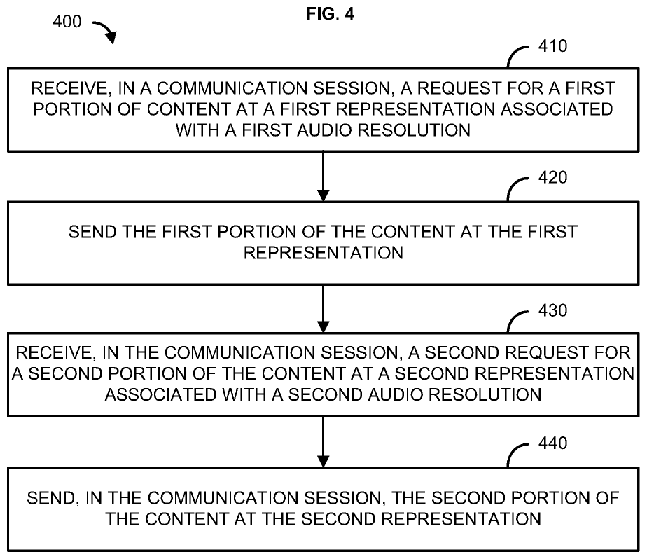

At 340, the second portion of the content at the second video representation may be sent. For example, the requested second portion of the content at the second requested video representation may be sent by the network device 126a to the user device 130a (e.g., the requesting device). For example, the requested second portion of the content at the second requested video representation may be sent in the third file (e.g., a TS or BMFF file). For example, the second portion of the content at the second requested video representation may be sent via the communication session. For example, the communication session between the network device 126a and the user device 130a may remain active between the time the user device 130a makes the request for the first portion of the content at the first requested video representation and the time the network device 126a sends the second portion of the content at the second requested video representation to the user device 130a. The user device 130a, may receive the second portion of the content and display and or store the second portion of the content. For example, network device 126a may cause the second portion of the content at the second requested video representation to be displayed on the user device 130a by sending the second portion of the content to the user device 130a. For example, the edge cache 124a and/or the network device 130a may comprise the first representation of the content and the second representation of the content FIG. 4 is a flowchart of an example method 400 for sending content at different representations to a device requesting the content. While the example of FIG. 4 will describe method 400 being completed by the network device 126a, this is for example purposes only, as all or any other portion of the method 400 may be completed by any other computing device described herein.

The requested content may be, for example, video content, audio content, audio/video content, web-based content, games, applications, data, streaming content, movies, shows/programs, etc. For example, the representations may be associated with video resolution, audio resolution, a combination of video and audio resolution, bitrate, coder-decoder setting (CODECs), and/or compression settings. For example, each representation may indicate or be associated with a requested audio resolution (e.g., CODEC, bitrate, compression setting, or the like) at which the requesting device wants to receive the content or the audio portion of the content. For example, each representation may indicate the requested audio resolution at which the requesting device will most efficiently receive or process the content. For example, the audio resolution may be any one or more of MP3, AAC, WAV, Ogg Vorbis, ALAC, FLAC, AIFF, DSD, MQA, or PCM. For example, the requested audio resolution may be associated with (e.g., sent at or intended to be sent at) a particular bitrate.

For example, each representation may indicate a requested video resolution (e.g., screen resolution) or bitrate at which the requesting device wants to receive the content or the video portion of the content. For example, each representation may indicate the requested video resolution/bitrate at which the requesting device will most efficiently receive or process the content. For example, the video resolution may be any one or more of 480p, 576p, 720p, 1080p, 1440p, 4K, or 8K. For example, the requested video resolution may be associated with (e.g., sent at or intended to be sent at) a particular bitrate.

A computing device (e.g., the edge caches 124a-c) may receive a plurality of files associated with one or more items of the content. For example, the edge caches 124a-c may receive the plurality of files from another computing device (e.g., the mid-tier cache 122) via a network. The mid-tier cache 122 may receive the plurality of files from yet another computing device (e.g., the computing device 106) via the network 120. While the example describes the mid-tier cache 122 receiving the plurality of files from the computing device 106, in other examples, one or more additional tiers or cache devices may be between the mid-tier cache 122 and the computing device 106 and/or between the mid-tier cache 122 and the edge caches 124a-c. For example, the computing device 106, the mid-tier cache 122 and the edge caches 124a-c may store copies of the plurality of files of the content item in associated storage devices.

For example, each file of the plurality of files may include a portion of a particular content item. For example, the particular content item may comprise a television show, a movie, a sporting event, a concert, a game, streaming content, an application, data, etc.). For example, the portion of the particular content item may be a segment of the content. For example, a plurality of segments (e.g., portions) may together make up the content item. For example, each segment may comprise or be associated with an amount of time or data of the content item. For example, each segment may comprise about two seconds of the content item. In other examples, each segment may comprise more or less than two seconds of the content item or a particular amount of data of the content item.

Each file of the plurality of files of the content item may comprise multiple representations of the particular portion of the content item. For example, each file may comprise representations associated with multiple audio resolutions and/or multiple video resolutions for the portion of the content item. For example, each file of the plurality of files may be an AMFF file. For example, each file may comprise a header as described in FIG. 2.

At 410, a request may be received for a portion of the content. For example, the portion of the content may comprise the first portion of the content. For example, the request may be received from a user device (e.g., the user device 130a). For example, the request may be received by a network device (e.g., the edge cache 124a, the network device 128 or the network device 126a). For example, the network device 126a may receive the request directly from the user device 130a or indirectly via the network device 128 and/or the edge cache 124a. For example, the network device 128 may comprise a container orchestrator 129. For example, the request for the content may comprise a user device identifier that identifies the user device 130a, the content identifier that identifies the content being requested, an identifier of the first portion or segment of the content requested, a first requested video representation (e.g., video resolution/bitrate), and/or a first requested audio representation (e.g., audio resolution or compression rate). While the example references the request being for the first portion of the content, this is for example purposes only as the request may be for any portion of the content and the reference to first is not intended to be limited to the actual first portion of the content. For example, the edge cache 124a and/or the network device 128 may evaluate the request and determine another network device (e.g., network device 126a) to associate with the user device 130a. For example, the edge cache 124a and/or the network device 128 may determine the network device 126a based on one or more of the identifier of the content being requested, the identifier of the user device, the first requested video representation, or the first requested audio representation. For example, the network device 128 (e.g., the container orchestrator 129) may instantiate or create the network device 126a. For example, the network device 126a may be created or instantiated by the container orchestrator 129 or another portion of the network device 128 based on the request from the user device 130a. For example, the container orchestrator 129 or another portion of the network device 128 may assign the network device 126a to handle the request from the user device 130a. The network device 128, may relay or send the request, received from the user device 130a, to the network device 126a.

The network device 126a may receive the request from the container orchestrator 129 or another portion of the network device 128. In another example, the network device 126a may receive the request directly from the user device 130a. The network device 126a may initiate a communication session with the user device 130a via a network. The communication session may comprise a wired communication session, a wireless communication session, or a combination thereof. The communication session between the network device 126a and the user device 130a may be a direct communication session or an indirect communication, with one or more additional nodes or network devices making up the communication path between the user device 130a and the network device 126a.

The network device 126a may evaluate the request. For example, the network device 126a may determine, based on the evaluation of the request, the identifier of the content being requested and the first portion of the content being requested. The network device 126a may send a request for the first portion of the content to an edge cache associated with the user device 130a and/or the network device 126a (e.g., the edge cache 124a). The request from the network device 126a may comprise one or more of the user device identifier, the content identifier, and the identifier of the first portion or segment of the content being requested. For example, the request may comprise a request for the AMFF file for the first portion or segment of the content.

The edge cache 124a may receive the request for the first portion of the content from the network device 126a. The edge cache 124a may evaluate the request to determine a file of the plurality of files of the content that corresponds to or is associated with the first portion or segment of the content being requested. For example, the edge cache 124a may determine the file based on the content identifier and/or the identifier of the first portion or segment of the content being requested in the request from the network device 126a. The determined file comprising the first portion of the content being requested may comprise multiple representations of the first portion of the content. For example, the file may comprise multiple representations of the first portion of the content that are each associated with a different one of the multiple audio resolutions of the first portion of the content. For example, the file may comprise two or more representations of the portion of the content, each associated with a different audio resolution of the first portion of the content item.

The edge cache 124a may send the file comprising the first portion of the content being requested to the network device 126a. The network device 126a may receive the file comprising the first portion of the content being requested and store the file in memory.

The network device 126a may evaluate the request received from the user device 130a to determine the first requested audio representation (e.g., audio resolution or bitrate). The network device 126a may, based on the first requested audio representation, identify or determine the representation of the first portion of the content associated with the first requested audio representation in the file of the first portion of the content. For example, the representation of the first portion of the content may be associated with the first requested audio representation when the representation of the first portion of the content has an audio representation (e.g., resolution/bitrate) that matches or corresponds to the first requested audio representation.

The network device 126a may copy, extract, or remove the bytes associated with the determined representation of the first portion of the content associated with the first requested audio representation from the file of the first portion of the content. The network device 126a may repackage the copied, extracted, or removed bytes comprising the first requested audio representation of the portion of the content into a second file to be sent to the user device 130a. For example, the second file may be one of a TS file or a BMFF file, or another file format. For example, the second file may only include the first portion of the content in a single audio representation (e.g., the first requested audio representation).

At 420, the first portion of the content at the first audio representation may be sent. For example, the requested first portion of the content at the requested first audio representation may be sent by the network device 126a to the user device 130a (e.g., the requesting device). For example, the requested first portion of the content at the requested first audio representation may be sent in the second file (e.g., a TS or BMFF file). For example, the requested first portion of the content at the requested first audio representation may be sent via the communication session. For example, the communication session between the network device 126a and the user device 130a may remain active between the time the user device 130a makes the request for the first portion of the content and the time the network device 126a sends the first portion of the content to the user device 130a. The user device 130a, may receive the first portion of the content and display and or store the first portion of the content. For example, network device 126a may cause the first portion of the content to be displayed at the first requested audio representation on the user device 130a by sending the first portion of the content to the user device 130a.

At 430, a second request for a second portion of the content may be received. For example, the second request may be received by the network device 126a from the user device 130a. For example, the second request for the second portion of the content may comprise a user device identifier that identifies the user device 130a, the content identifier that identifies the content being requested, an identifier of the second portion or segment of the content requested, a second requested video representation (e.g., video resolution/bitrate), and/or a second requested audio representation (e.g., audio resolution or compression rate). For example, the second requested audio representation is different than the first requested audio representation.

For example, the second request may be received via the communication session. For example, the communication session between the network device 126a and the user device 130a may remain active between the time the user device 130a makes the request for the first portion of the content at the first audio representation and the time the network device 126a receives the second request for the second portion of the content at the second audio representation. While the example references the request being for the second portion of the content, this is for example purposes only as the request may be for any portion of the content and the reference to second is not intended to be limited to a particular portion of the content.

The network device 126a may evaluate the second request. For example, the network device 126a may determine, based on the evaluation of the second request, the identifier of the content being requested and the second portion of the content being requested. The network device 126a may send a request for the second portion of the content to the edge cache 124a. The request from the network device 126a may comprise one or more of the user device identifier, the content identifier, and the identifier of the second portion or segment of the content being requested. For example, the request may comprise a request for the AMFF file for the second portion or segment of the content.

The edge cache 124a may receive the request for the second portion of the content from the network device 126a. The edge cache 124a may evaluate the request to determine a file of the plurality of files of the content that corresponds to or is associated with the second portion or segment of the content being requested. For example, the edge cache 124a may determine the file based on the content identifier and/or the identifier of the second portion or segment of the content being requested in the request from the network device 126a. The determined file comprising the second portion of the content being requested may comprise multiple representations of the second portion of the content. For example, the file may comprise multiple representations of the second portion of the content that are each associated with a different one of the multiple video resolutions of the second portion of the content. For example, the file may comprise two or more representations of the second portion of the content, each associated with a different audio resolution of the second portion of the content item.

The edge cache 124a may send the file comprising the second portion of the content being requested to the network device 126a. The network device 126a may receive the file comprising the second portion of the content being requested and store the file in memory.

The network device 126a may evaluate the second request received from the user device 130a to determine the second requested audio representation (e.g., video resolution/bitrate). The network device 126a may, based on the second requested audio representation, identify or determine the representation of the second portion of the content associated with the second requested audio representation in the file of the second portion of the content. For example, the representation of the second portion of the content may be associated with the second requested audio representation when the representation of the second portion of the content has an audio representation (e.g., resolution/bitrate) that matches or corresponds to the second requested audio representation.

The network device 126a may copy, extract, or remove the bytes associated with the determined representation of the second portion of the content associated with the second requested audio representation from the file of the second portion of the content. The network device 126a may repackage the copied, extracted, or removed bytes comprising the second requested audio representation of the second portion of the content into a third file to be sent to the user device 130a. For example, the third file may be one of the TS file, the BMFF file, or another file format. For example, the third file may only include the second portion of the content in a single audio representation (e.g., the second requested audio representation different from the first requested audio representation).

At 440, the second portion of the content at the second audio representation may be sent. For example, the requested second portion of the content at the second requested audio representation may be sent by the network device 126a to the user device 130a (e.g., the requesting device). For example, the requested second portion of the content at the second requested audio representation may be sent in the third file (e.g., the TS or BMFF file). For example, the second portion of the content at the second requested audio representation may be sent via the communication session. For example, the communication session between the network device 126a and the user device 130a may remain active between the time the user device 130a makes the request for the first portion of the content at the first requested audio representation and the time the network device 126a sends the second portion of the content at the second requested audio representation to the user device 130a. The user device 130a, may receive the second portion of the content and display and or store the second portion of the content. For example, network device 126a may cause the second portion of the content at the second requested audio representation to be displayed on the user device 130a by sending the second portion of the content to the user device 130a.

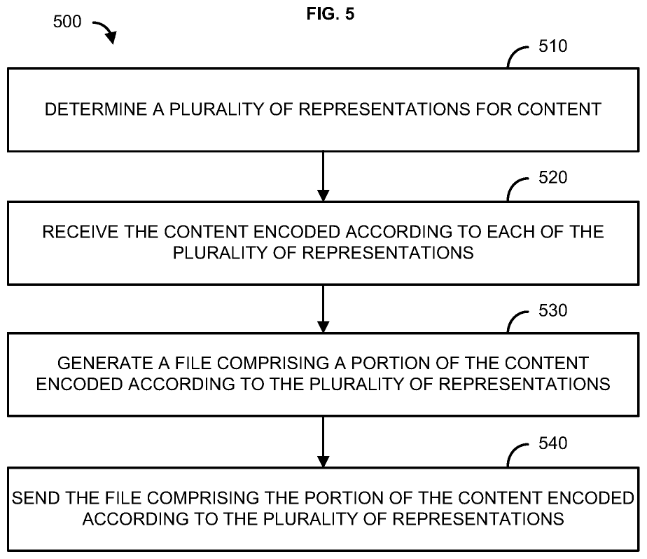

FIG. 5 is a flowchart of an example method 500 for packaging content in a file comprising a plurality of representations of the content. While the example of FIG. 5 will describe method 500 being completed by the computing device 106 and/or the encoder 104, which may be part of the computing device 106, this is for example purposes only, as all or any other portion of the method 500 may be completed by any other computing device described herein.

For example, the representations may be associated with video representation, audio representation or a combination of video representation and audio representation. For example, each representation may indicate or be associated with an audio resolution (e.g., CODEC, bitrate, compression setting, or the like) or a video resolution at which the content or portions of the content are encoded. For example, the audio resolution may indicate a format by which an audio portion of the content or portion of the content was encoded. For example, the audio resolution may be any one or more of MP3, AAC, WAV, Ogg Vorbis, ALAC, FLAC, AIFF, DSD, MQA, or PCM. For example, each audio resolution may be associated with (e.g., sent at or intended to be sent at) a particular bitrate. For example, the video resolution may indicate a format by which a video portion of the content or portion of the content was encoded. For example, the video resolution may be any one or more of 480p, 576p, 720p, 1080p, 1440p, 4K, or 8K. For example, each video resolution may be associated with (e.g., sent at or intended to be sent at) a particular bitrate.

Content may be sent by the content source 102. The content may be, for example, video content, audio content, audio/video content, web-based content, games, applications, data, streaming content, movies, shows/programs, etc. The content may be live content, audio-on-demand content, and/or video-on-demand content. The content source 102 may receive the content from an external service or device (e.g., a stream capture source, a data storage device, a media server, etc.) via a wired or wireless network, such as network 120 or another network. The content source 102 may receive content for a plurality of content items. The content may comprise one or more content items. Each content item may be associated with a show, episode, event, game, application, or set of data.

The content may be received by one or more encoders 104. While the example of FIG. 1 shows a single encoder 104, this is for example purposes only, as the content may be received in whole or in part by any number of encoders 104. For example, different encoders may be configured to encode the content (e.g., content item) or portions of the content (e.g., portions of the content item) at different representations (e.g., different video representations and/or different audio representations), which may be associated with different audio resolutions, different video resolutions, and/or different bitrates.

At 510, a plurality of representations for encoding the content may be determined. For example, the plurality of representations may be determined by the encoder 104, the computing device 106, or any other computing device described herein. For example, the plurality of representations may comprise a plurality of video representations to encode the content or video portions of the content at. For example, the plurality of video representations may comprise a plurality of video resolutions or a plurality of bitrates to encode the content or video portions of the content at. For example, the plurality of representations may comprise a plurality of audio representations to encode the content or audio portions of the content at. For example, the plurality of audio representations may comprise a plurality of audio resolutions, CODECs, compression rates, and/or bitrates at which to encode the content or audio portions of the content.

For example, the plurality of representations may be preset or predetermined and stored within memory (e.g., data storage 112) associated with the encoder 104 and/or the computing device 106. For example, the plurality of representations to encode the content may be dynamically determined based on one or more of the type of content (e.g., video content, audio content, audio/video content, web-based content, games, applications, or data), the source of the content, the size of the content, or the destination of the content.

The content may be encoded according to each of the plurality of representations. For example, the content may be encoded based on the determined plurality of representations for the content. For example, the content may be encoded by the one or more encoders 104 separate from or part of the computing device 106. For example, the content may be encoded according to a plurality of video representations, a plurality of audio representations, or both a plurality of video representations and a plurality of audio representations. For example, the video portion of the content may be encoded according to and based on the determined plurality of video representations. For example, the audio portion of the content may be encoded according to and based on the determined plurality of audio representations.

At 520, the content, encoded according to each of the plurality of representations may be received. For example, the content may be received by the computing device 106 or any other computing device described herein. For example, the receipt of the content may be part of an internal transmission within the computing device 106 or from one or more external computing devices, such as one or more encoders 104. For example, the computing device 106 may receive the content encoded according to a plurality of video representations, a plurality of audio representations, or both. As such, the computing device receives multiple copies of the content (or multiple copies of the video portion of the content and/or the audio portion of the content), each encoded according to a different video representation and/or audio representation.

The computing device 106 (e.g., the segmenter 108), or any other computing device described herein, may divide the received plurality of representations of the content into a plurality of portions or segments of each of the plurality of representations of the content. For example, the computing device 106 may break the encoded representations of the content into segments at key frame boundaries at or near particular time periods apart or data allotments within that content. For example, the computing device 106 may divide a first video representation of the content into a plurality of portions or segments of the first video representation of the content and may divide a second video representation of the content into a plurality of portions or segments of the second video representation of the content. Similarly, the computing device 106 may divide a first audio representation of the content into a plurality of portions or segments of the first audio representation of the content and may divide a second audio representation of the content into a plurality of portions or segments of the second audio representation of the content. While the examples above describe segmenting two video representations and two audio representations of the content, this is for example purposes only as the number of representations for one or both of the encoded video and audio of the content may be greater than or less than the two in the example.

At 530, a file may be generated that comprises a portion of the content encoded according to each of the plurality of received representations of the content. For example, the file may be generated by the computing device 106 (e.g., the packager 110) or any other computing device described herein. For example, the portion of the content may be a particular time allotment of the content (e.g., two seconds of the content) or a particular amount of data of the content for each of the representations of that portion of the content. As such, the file may comprise multiple versions of the same portion of the content, each encoded according to a different video representation and/or audio representation. For example, the file may comprise multiple versions of the portion of the content encoded according to different video representations of the content. For example, the file may comprise multiple versions of the portion of the content encoded according to different audio representations of the content. For example, a plurality of files may be generated, each file corresponding to a particular portion of a plurality of portions of the content. Each of the plurality of portions of the content may be associated with a different portion (e.g., time period, data range) of the particular content or content item. Each of the files of the plurality of files may comprises multiple versions of the same particular portion of the content (e.g., a first portion of the content, a second portion of the content, etc.) encoded according to multiple video representations and/or audio representations. For example, the file may be an AMFF file.

The file may comprise a header (e.g., header 200 of FIG. 2). The header 200 of the file may comprise an indicator of the file type 202. For example, the header 200 of the file indicates that the file type 202 is an AMFF file. The header 200 of the file may comprise an indicator of the number of representations 204 of the portion of the content being provided in the file. For example, the header 200 indicates the number of representations 204 of the portion of the content in the example file is five representations of the portion of the content. The header 200 of the file may comprise an indicator of the portion of the content 205 being provided in the file. For example, the header 200 indicates the portion of the content is the third portion of the content. The header 200 of the file may comprise an identifier of the particular representations 206, 212, 218, 224, 230 of the portion of the content being provided in the file. For example, the header 200 of the file identifies three video representations LE1 206, LE2 212, and LE3 218, and two audio representations enAAC 224, and LE2 230 of the portion of the content are being provided in the file. For example, each of the video representations being provided in the file may be associated with a different video resolution and/or different bitrate. For example, each of the audio representations being provided in the file may be associated with a different audio resolution and/or bitrate. For example, the header 200 of the file may comprise an indication of the bitrate or video resolution 208, 214, 220, or the bitrate or audio resolution 226, 232 of the corresponding video representations LE1 206, LE2 212, and LE3 218, and audio representations enAAC 224, and LE2 230 of the portion of the content being provided in the file. The header 200 of the file may comprise an indication of the run length 210, 216, 222, 228, 234 for each representation of the portion of the content in the file. The file may also include the data 236-244 (e.g., bytes) for each representation of the portion of the content item in the file. For example, the data 236-244 may comprise multiple copies of the same portion of the content (or video portion of the same portion of the content) at different video resolutions and/or bitrates. For example, the data 236-244 may comprise multiple copies of the same portion of the content (or audio portion of the same portion of the content) at different audio resolutions and/or bitrates.

At 540, the file comprising the portion of the content encoded according to the plurality of representations may be sent. For example, the file may be sent by the computing device 106 to one or more other computing device (e.g., the cache devices 122, 124a-c) via the network 120 or another network. For example, the computing device 106 may send the file to the one or more mid-tier (or remote) caches 122 via the network 120. For example, the computing device 106 may cause the one or more mid-tier caches 122 to send the file, comprising the portion of the content encoded according to the plurality of representations, to the one or more edge caches 124a-c via the network 120 or another network based on sending the file from the computing device 106 to the one or more mid-tier caches 122 via the network 120 or another network. The file may subsequently be sent by each edge cache 124a-c to corresponding network devices 126a-c via the network 120 or another network. The file may be stored in one or more of the computing device 106 (e.g., the data storage 112), the one or more mid-tier caches 122, the one or more edge (or local) caches 124a-c, and the one or more network devices 126a-c. While the example is described with reference to sending the file of the plurality of files that corresponds to the portion (e.g. first portion) of the content item, the same process may be used to generate and send the remaining plurality of the files for the other portions (e.g., second portion, third portion, etc.) of the content (or content item) in a similar manner as described above. Each of the plurality of the files of the content item may comprise an AMFF file. Each of the plurality of files of the content may comprise a different portion of the content and multiple versions of that portion of the content encoded according to multiple video representations and/or audio representations.

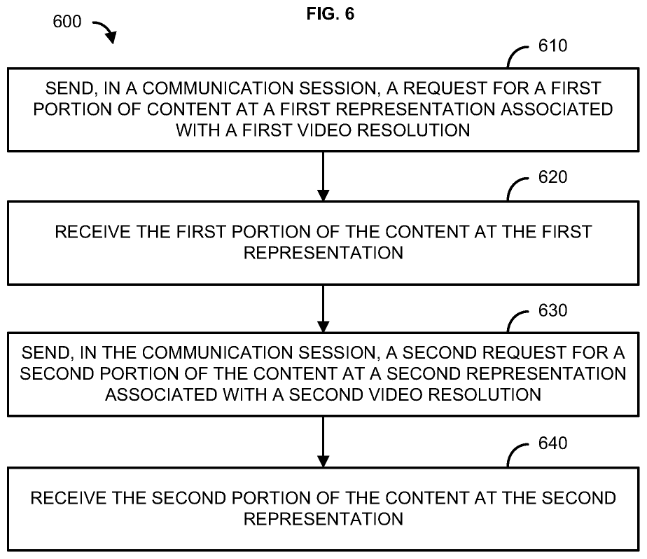

FIG. 6 is a flowchart of an example method 600 for receiving requested content at different representations. The methods described in FIG. 6 may be completed by a computing device (e.g., the user devices 130a-c or any other computing device described herein).

The requested content may be, for example, video content, audio content, audio/video content, web-based content, games, applications, data, streaming content, movies, shows/programs, etc. For example, the representations may be associated with video resolution, audio resolution, a combination of video and audio resolution, bitrate, coder-decoder setting (CODECs), and/or compression settings.

For example, each representation may indicate a requested video resolution (e.g., screen resolution/bitrate) at which the requesting device (e.g., the user device 130a) wants to receive the content. For example, each representation may indicate the requested video resolution/bitrate at which the user device 130a will most efficiently receive or process the content. For example, the video resolution may be any one or more of 480p, 576p, 720p, 1080p, 1440p, 4K, or 8K. For example, the requested video resolution may be associated with (e.g., sent at or intended to be sent at) a particular bitrate.

For example, each representation may indicate a requested audio resolution (e.g., CODEC, bitrate, compression setting, or the like) at which the user device 130a wants to receive the content. For example, each representation may indicate the requested audio resolution at which the user device 130a will most efficiently receive or process the content. For example, the audio resolution may be any one or more of MP3, AAC, WAV, Ogg Vorbis, ALAC, FLAC, AIFF, DSD, MQA, or PCM. For example, the requested audio resolution may be associated with (e.g., sent at or intended to be sent at) a particular bitrate.

At 610, a request for a portion of content may be sent. For example, the portion of the content may comprise the first portion of the content. For example, the request may be sent from a user device (e.g., the user device 130a) to a network device (e.g., the edge cache 124a, the network device 128, or the network device 126a). For example, user device 130a may send the request directly to the network device 126a or indirectly to the network device 126a via the network device 128 or the edge cache 124a. For example, the request for the content may comprise a user device identifier that identifies the user device 130a, the content identifier that identifies the content being requested, an identifier of the first portion or segment of the content requested, a first requested video representation (e.g., video resolution/bitrate), and/or a first requested audio representation (e.g., audio resolution or compression rate). While the example references the request being for the first portion of the content, this is for example purposes only as the request may be for any portion of the content and the reference to first is not intended to be limited to the actual first portion of the content.

The edge cache 124a and/or the network device 128 (e.g., the container orchestrator 129) may evaluate the request and determine another network device (e.g., network device 126a) to associate with the user device 130a. For example, the edge cache 124a and/or the container orchestrator 129 or another portion of the network device 128 may determine the network device 126a based on one or more of the identifier of the content being requested, the identifier of or associated with the user device, the first requested video representation, or the first requested audio representation. For example, the container orchestrator 129 or another portion of the network device 128 may instantiate or create the network device 126a. For example, the network device 126a may be created or instantiated by the container orchestrator 129 or another portion network device 128 based on the request sent by the user device 130a. For example, the container orchestrator 129 or another portion of the network device 128 may assign the network device 126a to handle the sent request based on the user device 130a sending the request for the first portion of the content. The network device 128, may relay or send the request received from the user device 130a to the network device 126a.

The network device 126a may receive the request from the container orchestrator 129 or another portion of the network device 128 and/or the user device 130a. The network device 126a may initiate a communication session with the user device 130a via a network based on receiving the request for the content from the user device 130a. The communication session may comprise a wired communication session, a wireless communication session, or a combination thereof. The communication session between the network device 126a and the user device 130a may be a direct communication session or an indirect communication, with one or more additional nodes or network devices making up the communication path between the user device 130a and the network device 126a.

The network device 126a may evaluate the request sent by the user device 130a. For example, the network device 126a may determine, based on the evaluation of the request, the identifier of the content being requested and the portion (e.g., first portion) of the content being requested. The network device 126a may also determine the requested video representation, such as the first requested video representation (e.g., video resolution/bitrate) in the request for the content. The network device 126a may, based on one or more of the content identifier, the first portion of the content, or the first requested video representation, identify or determine the representation of the first portion of the content associated with the first requested video representation in a file of the first portion of the content. For example, the file of the first portion of the content may comprise multiple versions of the first portion of the content, each version encoded based on different audio and/or video representations. For example, the representation of the first portion of the content may be associated with the first requested video representation when the representation of the first portion of the content has a video representation (e.g., resolution or bitrate) that matches or corresponds to the first requested video representation in the request for content from the user device 130a.

The network device 126a may copy, extract, or remove the bytes associated with the determined representation of the first portion of the content associated with the first requested video representation from the file (e.g., an AMFF file) of the first portion of the content. The network device 126a may repackage the copied, extracted, or removed bytes comprising the first requested video representation of the portion of the content into a second file to be sent to the user device 130a. For example, the second file may be one of a TS file, a BMFF file, or another file format. For example, the second file may only include the first portion of the content encoded according to a single video representation (e.g., the first requested video representation).

At 620, the first portion of the content at the first video representation may be received. For example, the requested first portion of the content at the requested first video representation may be received by the user device 130a (e.g., the requesting device) from the network device 126a. For example, the requested first portion of the content at the requested first video representation may be received in the form of the second file (e.g., a TS or BMFF file). For example, the requested first portion of the content at the requested first video representation may be received via the communication session. For example, the communication session between the network device 126a and the user device 130a may remain active between the time the user device 130a makes the request for the first portion of the content and the time the user device 130a receives the first portion of the content from the network device 126a. The user device 130a, may receive the first portion of the content and display and or store the first portion of the content. For example, the user device 130a may display the first portion of the content in the first requested video representation on a display associated with the user device 130a.

At 630, a second request for a second portion of the content may be sent. For example, the second request may be sent by the user device 130a to the network device 126a. For example, the second request for the second portion of the content may comprise the user device identifier that identifies the user device 130a, the content identifier that identifies the content being requested, an identifier of the second portion or segment of the content requested, a second requested video representation (e.g., video resolution/bitrate), and/or a second requested audio representation (e.g., audio resolution or compression rate). For example, the second requested video representation is different than the first requested video representation.

For example, the second request may be sent by the user device 130a to the network device 126a via the communication session. For example, the communication session between the network device 126a and the user device 130a may remain active between the time the user device 130a sends the request for the first portion of the content at the first video representation and the time the user device 130a sends the second request for the second portion of the content at the second video representation. While the example references the second request being for the second portion of the content, this is for example purposes only as the second request may be for any portion of the content and the reference to second is not intended to be limited to a particular portion of the content.

The network device 126a may evaluate the second request sent by the user device 130a. For example, the network device 126a may determine, based on the evaluation of the second request, the identifier of the content being requested and the portion (e.g., second portion) of the content being requested. The network device 126a may also determine the requested video representation, such as the second requested video representation (e.g., video resolution/bitrate) in the second request for the content. The network device 126a may, based on one or more of the content identifier, the identifier of the second portion of the content, or the second requested video representation, identify or determine the representation of the second portion of the content associated with the second requested video representation in a file of the second portion of the content at the network device 126a. For example, the file of the second portion of the content may comprise multiple versions of the second portion of the content, each version encoded based on different audio representations and/or video representations. For example, the representation of the second portion of the content may be associated with the second requested video representation when the representation of the second portion of the content has a video representation (e.g., resolution or bitrate) that matches or corresponds to the second requested video representation in the second request for content sent by the user device 130a.

The network device 126a may copy, extract, or remove the bytes associated with the determined representation of the second portion of the content associated with the second requested video representation from the file of the second portion of the content. The network device 126a may repackage the copied, extracted, or removed bytes comprising the second requested video representation of the second portion of the content into a third file to be sent to the user device 130a. For example, the third file may be one of the TS file, the BMFF file, or another file format. For example, the third file may only include the second portion of the content encoded according to a single video representation (e.g., the second requested video representation different from the first requested video representation).

At 640, the second portion of the content at the second video representation may be received. For example, the requested second portion of the content at the second requested video representation may be received by the user device 130a from the network device 126a. For example, the requested second portion of the content at the second requested video representation may be received in the form of the third file (e.g., a TS or BMFF file). For example, the second portion of the content at the second requested video representation may be received via the communication session. For example, the communication session between the network device 126a and the user device 130a may remain active between the time the user device 130a sends the request for the first portion of the content at the first requested video representation and the time the user device 130a receives the second portion of the content at the second requested video representation from the network device 126a. The user device 130a, may receive the second portion of the content and display and or store the second portion of the content. For example, the user device 130a may display the first portion of the content in the first requested video representation on a display associated with the user device 130a.

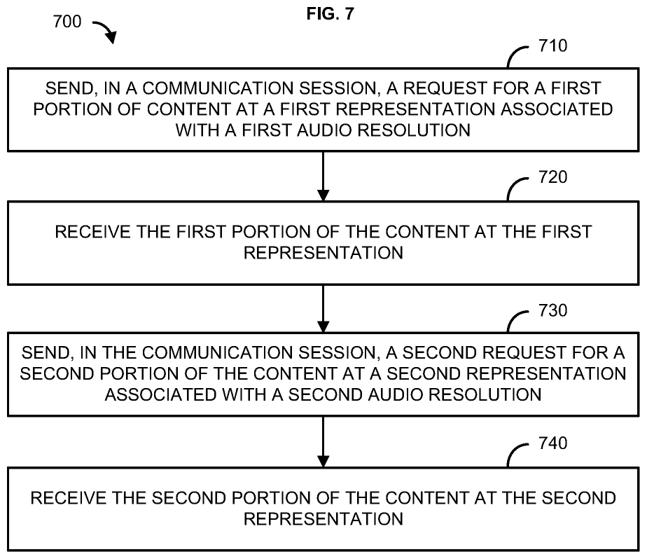

FIG. 7 is a flowchart of an example method 700 for receiving requested content at different representations. The methods described in FIG. 7 may be completed by a computing device (e.g., the user devices 130a-c or any other computing device described herein).

The requested content may be, for example, video content, audio content, audio/video content, web-based content, games, applications, data, streaming content, movies, shows/programs, etc. For example, the representations may be associated with video resolution, audio resolution, a combination of video and audio resolution, bitrate, coder-decoder setting (CODECs), and/or compression settings. For example, each representation may indicate or be associated with a requested audio resolution (e.g., CODEC, bitrate, compression setting or the like) at which the user device 130a wants to receive the content or the audio portion of the content. For example, each representation may indicate the requested audio resolution at which the user device 130a will most efficiently receive or process the content. For example, the audio resolution may be any one or more of MP3, AAC, WAV, Ogg Vorbis, ALAC, FLAC, AIFF, DSD, MQA, or PCM. For example, the requested audio resolution may be associated with (e.g., sent at or intended to be sent at) a particular bitrate.

For example, each representation may indicate a requested video resolution (e.g., screen resolution/bitrate) at which the requesting device (e.g., the user device 130a) wants to receive the content. For example, each representation may indicate the requested video resolution/bitrate at which the user device 130a will most efficiently receive or process the content. For example, the video resolution may be any one or more of 480p, 576p, 720p, 1080p, 1440p, 4K, or 8K. For example, the requested video resolution may be associated with (e.g., sent at or intended to be sent at) a particular bitrate.

At 710, a request for a portion of content may be sent. For example, the portion of the content may comprise the first portion of the content. For example, the request may be sent from a user device (e.g., the user device 130a) to a network device (e.g., the edge cache 124a, the network device 128, or the network device 126a). For example, user device 130a may send the request directly to the network device 126a or indirectly to the network device 126a via the edge cache 124a and/or the network device 128. For example, the request for the content may comprise a user device identifier that identifies the user device 130a, the content identifier that identifies the content being requested, an identifier of the first portion or segment of the content requested, a first requested video representation (e.g., video resolution/bitrate), and/or a first requested audio representation (e.g., audio resolution/compression rate/bitrate). While the example references the request being for the first portion of the content, this is for example purposes only as the request may be for any portion of the content and the reference to first is not intended to be limited to the actual first portion of the content.

The network device 126a may receive the request from the edge cache 124a, the network device 128 (e.g., the container orchestrator 129), and/or the user device 130a. The network device 126a may initiate a communication session with the user device 130a via a network based on receiving the request for the content from the user device 130a. The communication session may comprise a wired communication session, a wireless communication session, or a combination thereof. The communication session between the network device 126a and the user device 130a may be a direct communication session or an indirect communication, with one or more additional nodes or network devices making up the communication path between the user device 130a and the network device 126a.

The network device 126a may evaluate the request sent by the user device 130a. For example, the network device 126a may determine, based on the evaluation of the request, the identifier of the content being requested and the portion (e.g., first portion) of the content being requested. The network device 126a may also determine the requested audio representation, such as the first requested audio representation (e.g., audio resolution/compression rate/bitrate) in the request for the content. The network device 126a may, based on one or more of the content identifier, the first portion of the content, or the first requested audio representation, identify or determine the representation of the first portion of the content associated with the first requested audio representation in a file of the first portion of the content. For example, the file of the first portion of the content may comprise multiple versions of the first portion of the content, each version encoded based on different audio representations and/or video representations. For example, the representation of the first portion of the content may be associated with the first requested audio representation when the representation of the first portion of the content has an audio representation (e.g., audio resolution/compression rate/bitrate) that matches or corresponds to the first requested audio representation in the request for content from the user device 130a.

The network device 126a may copy, extract, or remove the bytes associated with the determined representation of the first portion of the content associated with the first requested audio representation from the file (e.g., an AMFF file) of the first portion of the content. The network device 126a may repackage the copied, extracted, or removed bytes comprising the first requested audio representation of the portion of the content into a second file to be sent to the user device 130a. For example, the second file may be one of a TS file, a BMFF file, or another file format. For example, the second file may only include the first portion of the content encoded according to a single audio representation (e.g., the first requested audio representation).

At 720, the first portion of the content at the first audio representation may be received. For example, the requested first portion of the content at the requested first audio representation may be received by the user device 130a from the network device 126a. For example, the requested first portion of the content at the requested first audio representation may be received in the form of the second file (e.g., a TS or BMFF file). For example, the requested first portion of the content at the requested first audio representation may be received via the communication session. For example, the communication session between the network device 126a and the user device 130a may remain active between the time the user device 130a makes the request for the first portion of the content and the time the user device 130a receives the first portion of the content from the network device 126a. The user device 130a, may receive the first portion of the content and display and or store the first portion of the content. For example, the user device 130a may display the first portion of the content in the first requested audio representation on a display associated with the user device 130a.

At 730, a second request for a second portion of the content may be sent. For example, the second request may be sent by the user device 130a to the network device 126a. For example, the second request for the second portion of the content may comprise the user device identifier that identifies the user device 130a, the content identifier that identifies the content being requested, an identifier of the second portion or segment of the content requested, a second requested video representation (e.g., video resolution/bitrate), and/or a second requested audio representation (e.g., audio resolution/compression rate/bitrate). For example, the second requested audio representation is different than the first requested audio representation.

For example, the second request may be sent by the user device 130a to the network device 126a via the communication session. For example, the communication session between the network device 126a and the user device 130a may remain active between the time the user device 130a sends the request for the first portion of the content at the first audio representation and the time the user device 130a sends the second request for the second portion of the content at the second audio representation. While the example references the second request being for the second portion of the content, this is for example purposes only as the second request may be for any portion of the content and the reference to second is not intended to be limited to a particular portion of the content.

The network device 126a may evaluate the second request sent by the user device 130a. For example, the network device 126a may determine, based on the evaluation of the second request, the identifier of the content being requested and the portion (e.g., second portion) of the content being requested. The network device 126a may also determine the requested audio representation, such as the second requested audio representation (e.g., audio resolution/compression rate/bitrate) in the second request for the content. The network device 126a may, based on one or more of the content identifier, the identifier of the second portion of the content, or the second requested audio representation, identify or determine the representation of the second portion of the content associated with the second requested audio representation in a file of the second portion of the content at the network device 126a. For example, the file of the second portion of the content may comprise multiple versions of the second portion of the content, each version encoded based on different audio representations and/or video representations. For example, the representation of the second portion of the content may be associated with the second requested audio representation when the representation of the second portion of the content has an audio representation (e.g., audio resolution/compression rate/bitrate) that matches or corresponds to the second requested audio representation in the second request for content sent by the user device 130a.

The network device 126a may copy, extract, or remove the bytes associated with the determined representation of the second portion of the content associated with the second requested audio representation from the file of the second portion of the content. The network device 126a may repackage the copied, extracted, or removed bytes comprising the second requested audio representation of the second portion of the content into a third file to be sent to the user device 130a. For example, the third file may be one of the TS file, the BMFF file, or another file format. For example, the third file may only include the second portion of the content encoded according to a single audio representation (e.g., the second requested audio representation different from the first requested audio representation).

At 740, the second portion of the content at the second audio representation may be received. For example, the requested second portion of the content at the second requested audio representation may be received by the user device 130a from the network device 126a. For example, the requested second portion of the content at the second requested audio representation may be received in the form of the third file (e.g., the TS or BMFF file). For example, the second portion of the content at the second requested audio representation may be received via the communication session. For example, the communication session between the network device 126a and the user device 130a may remain active between the time the user device 130a sends the request for the first portion of the content at the first requested audio representation and the time the user device 130a receives the second portion of the content at the second requested audio representation from the network device 126a. The user device 130a, may receive the second portion of the content and display and or store the second portion of the content. For example, the user device 130a may display the second portion of the content in the second requested audio representation on a display associated with the user device 130a.

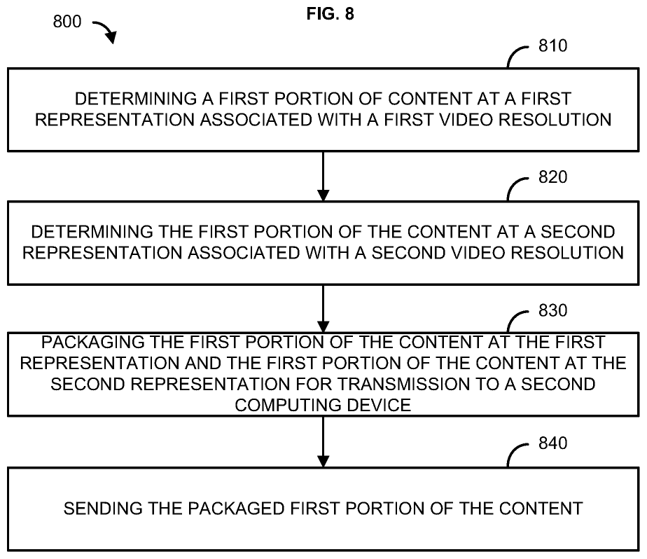

FIG. 8 is a flowchart of an example method 800 for packaging content in a file comprising a plurality of representations of the content. While the example of FIG. 8 will describe method 800 being completed by the computing device 106 and/or the encoder 104, which may be part of the computing device 106, this is for example purposes only, as all or any other portion of the method 800 may be completed by any other computing device described herein.

For example, the representations may be associated with video representation, audio representation or a combination of video representation and audio representation. For example, each audio resolution may be associated with (e.g., sent at or intended to be sent at) a particular bitrate. For example, the video resolution may indicate a format by which a video portion of the content or portion of the content was encoded. For example, the video resolution may be any one or more of 480p, 576p, 720p, 1080p, 1440p, 4K, or 8K. For example, each video resolution may be associated with (e.g., sent at or intended to be sent at) a particular bitrate. For example, each representation may indicate or be associated with an audio resolution (e.g., CODEC, bitrate, compression setting, or the like) or a video resolution at which the content or portions of the content are encoded. For example, the audio resolution may indicate a format by which an audio portion of the content or portion of the content was encoded. For example, the audio resolution may be any one or more of MP3, AAC, WAV, Ogg Vorbis, ALAC, FLAC, AIFF, DSD, MQA, or PCM.

Content may be sent by the content source 102. The content may be, for example, video content, audio content, audio/video content, web-based content, games, applications, data, streaming content, movies, shows/programs, etc. The content may be live content, or on-demand content. The content source 102 may receive the content from an external service or device (e.g., a stream capture source, a data storage device, a media server, etc.) via a wired or wireless network, such as network 120 or another network. The content source 102 may receive content for a plurality of content items. The content may comprise one or more content items. Each content item may be associated with a show, episode, event, game, application, or set of data.

The content may be received by one or more encoders 104. While the example of FIG. 1 shows a single encoder 104, this is for example purposes only, as the content may be received in whole or in part by any number of encoders 104. For example, different encoders may be configured to encode the content (e.g., content item) or portions of the content (e.g., portions of the content item) at different representations (e.g., different video representations and/or different audio representations), which may be associated with different audio resolutions, different video resolutions, and/or different bitrates.

The content may be encoded by the one or more encoders 104 separate from or part of the computing device 106. For example, the content may be encoded according to a plurality of video representations, a plurality of audio representations, or both a plurality of video representations and a plurality of audio representations. For example, the video portion of the content may be encoded according to and based on the determined plurality of video representations. For example, the audio portion of the content may be encoded according to and based on the determined plurality of audio representations.

The content, encoded according to each of the plurality of representations may be received. For example, the content may be received by the computing device 106 or any other computing device described herein. For example, the receipt of the content may be part of an internal transmission within the computing device 106 or from one or more external computing devices, such as one or more encoders 104. For example, the computing device 106 may receive the content encoded according to a plurality of video representations, a plurality of audio representations, or both. As such, the computing device 106 may receive multiple copies of the content (or multiple copies of the video portion of the content and/or the audio portion of the content), each encoded according to a different video representation and/or audio representation.

The computing device 106 (e.g., the segmenter 108), or any other computing device described herein, may divide the received plurality of representations of the content into a plurality of portions or segments of each of the plurality of representations of the content. For example, the computing device 106 may break the encoded representations of the content into segments at key frame boundaries at or near particular time periods apart or data allotments within that content. For example, the computing device 106 may divide a first video representation of the content into a plurality of portions or segments of the first video representation of the content and may divide a second video representation of the content into a plurality of portions or segments of the second video representation of the content. Similarly, the computing device 106 may divide a first audio representation of the content into a plurality of portions or segments of the first audio representation of the content and may divide a second audio representation of the content into a plurality of portions or segments of the second audio representation of the content. While the examples above describe segmenting two video representations and two audio representations of the content, this is for example purposes only as the number of representations for one or both of the encoded video and audio of the content may be greater than or less than the two in the example.

At 810, a first portion of the content at a first representation may be determined. For example, the first portion of the content at the first representation may be determined by the computing device 106 or any other computing device described herein. For example, the first portion of the content at the first representation may be determined based on the plurality of portions or segments of the first video representation of the content. For example, the first video representation may be associated with a first video resolution. For example, the first video representation may be associated with a first bitrate.

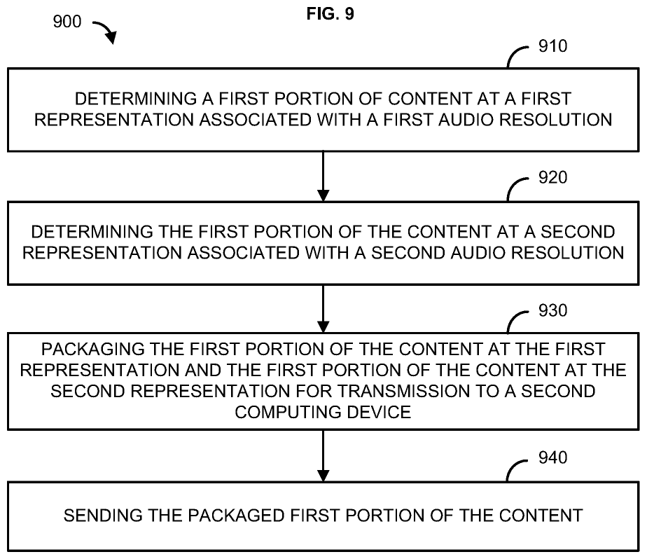

At 820, a first portion of the content at a second representation may be determined. For example, the first portion of the content at the second representation may be determined by the computing device 106 or any other computing device described herein. For example, the first portion of the content at the second representation may be determined based on the plurality of portions or segments of the second video representation of the content. For example, the second representation may be different from the first representation. For example, the second video representation may be different from the first video representation. For example, the second video representation may be associated with a second video resolution. For example, the second video resolution may be different from the first video resolution. For example, the second video representation may be associated with a second bitrate. For example, the second bitrate may be different from the first bitrate. For example, the computing device 106 may further determine a first portion of the content at a first audio representation and a first portion of the content at a second audio representation in substantially the same manner as described in 910 and 920 of FIG. 9.

At 830, the first portion of the content at the first representation and the first portion of the content at the second representation may be packaged for sending or transmission to a second computing device. For example, the first portion of the content at the first representation and the first portion of the content at the second representation may be packaged by the computing device 106 (e.g., the packager 110) or any other computing device described herein. For example, the second computing device may be one or more of the one or more mid-tier caches 122, the one or more edge caches 124a-c, and/or the one or more network devices 126a-c.

For example, the first portion of the content at the first representation and the first portion of the content at the second representation may be packaged in a file. For example, the file may be an AMFF file. For example, each portion of the content may be a particular time allotment of the content (e.g., two seconds of the content) or a particular amount of data of the content for each of the representations of that portion of the content. As such, the file may comprise multiple versions of the same portion of the content, each encoded according to a different video representation and/or audio representation. For example, the file may comprise multiple versions of the portion of the content encoded according to different video representations (e.g., the first representation and the second representation) of the content. For example, a plurality of files may be generated, each file corresponding to a particular portion of a plurality of portions of the content. Each of the plurality of portions of the content may be associated with a different portion (e.g., time period, data range) of the particular content or content item. Each of the files of the plurality of files may comprises multiple versions of the same particular portion of the content (e.g., a first portion of the content, a second portion of the content, etc.) encoded according to multiple video representations and/or audio representations. The file may indicate the first portion of the content at the first representation and the first portion of the content at the second representation in a header of the file. For example, the file may indicate the first portion of the content at the first representation and the first portion of the content at the second representation in a header the same as or similar to the header 200 of FIG. 2. Similarly, if the file also includes the first portion of the content at a first audio representation and the first portion of the content at a second audio representation, the header of the file may also include this information in a manner the same as or similar to the header 200 of FIG. 2.

At 840, the packaged first portion of the content may be sent. For example, the packaged first portion of the content may be sent by the computing device 106 to one or more other computing device (e.g., the cache devices 122, 124a-c) via the network 120 or another network. For example, the computing device 106 may send the packaged first portion of the content to the one or more mid-tier (or remote) caches 122 via the network 120. For example, the computing device 106 may cause the one or more mid-tier caches 122 to send the packaged first portion of the content to the one or more edge caches 124a-c via the network 120 or another network based on sending the packaged first portion of the content from the computing device 106 to the one or more mid-tier caches 122 via the network 120 or another network. The packaged first portion of the content may subsequently be sent by each edge cache 124a-c to corresponding network devices 126a-c via the network 120 or another network. The packaged first portion of the content may be stored in one or more of the computing device 106 (e.g., the data storage 112), the one or more mid-tier caches 122, the one or more edge (or local) caches 124a-c, and the one or more network devices 126a-c. While the example is described with reference to sending the packaged first portion of the content, the same process may be used to package and send all other portions (e.g., second portion, third portion, etc.) of the content (or content item) in a similar manner as described above. Each of the packaged portions (e.g., plurality of packaged portions) of the content (e.g., content item) may comprise an AMFF file. Each of the plurality of packaged portions of the content may comprise a different portion of the content and multiple versions of that portion of the content encoded according to multiple video representations and/or audio representations.

FIG. 9 is a flowchart of an example method 900 for packaging content in a file comprising a plurality of representations of the content. While the example of FIG. 9 will describe method 900 being completed by the computing device 106 and/or the encoder 104, which may be part of the computing device 106, this is for example purposes only, as all or any other portion of the method 900 may be completed by any other computing device described herein.

For example, each representation may indicate or be associated with an audio resolution (e.g., CODEC, bitrate, compression setting, or the like) or a video resolution at which the content or portions of the content are encoded. For example, the audio resolution may indicate a format by which an audio portion of the content or portion of the content was encoded. For example, the audio resolution may be any one or more of MP3, AAC, WAV, Ogg Vorbis, ALAC, FLAC, AIFF, DSD, MQA, or PCM. For example, the representations may be associated with video representation, audio representation or a combination of video representation and audio representation. For example, each audio resolution may be associated with (e.g., sent at or intended to be sent at) a particular bitrate. For example, the video resolution may indicate a format by which a video portion of the content or portion of the content was encoded. For example, the video resolution may be any one or more of 480p, 576p, 720p, 1080p, 1440p, 4K, or 8K. For example, each video resolution may be associated with (e.g., sent at or intended to be sent at) a particular bitrate.

Content may be sent by the content source 102. The content may be, for example, video content, audio content, audio/video content, web-based content, games, applications, data, streaming content, movies, shows/programs, etc. The content may be live content, or on-demand content. The content source 102 may receive the content from an external service or device (e.g., a stream capture source, a data storage device, a media server, etc.) via a wired or wireless network, such as network 120 or another network. The content source 102 may receive content for a plurality of content items. The content may comprise one or more content items. Each content item may be associated with a show, episode, event, game, application, or set of data.

The content may be received by one or more encoders 104. While the example of FIG. 1 shows a single encoder 104, this is for example purposes only, as the content may be received in whole or in part by any number of encoders 104. For example, different encoders may be configured to encode the content (e.g., content item) or portions of the content (e.g., portions of the content item) at different representations (e.g., different video representations and/or different audio representations), which may be associated with different audio resolutions, different video resolutions, and/or different bitrates.

The content may be encoded by the one or more encoders 104 separate from or part of the computing device 106. For example, the content may be encoded according to a plurality of audio representations, a plurality of video representations, or both a plurality of video representations and a plurality of audio representations. For example, the audio portion of the content may be encoded according to and based on the determined plurality of audio representations. For example, the video portion of the content may be encoded according to and based on the determined plurality of video representations.

The content, encoded according to each of the plurality of representations may be received. For example, the content may be received by the computing device 106 or any other computing device described herein. For example, the receipt of the content may be part of an internal transmission within the computing device 106 or from one or more external computing devices, such as one or more encoders 104. For example, the computing device 106 may receive the content encoded according to a plurality of audio representations, a plurality of video representations, or both. As such, the computing device 106 may receive multiple copies of the content (or multiple copies of the video portion of the content and/or the audio portion of the content), each encoded according to a different audio representation and/or video representation.

The computing device 106 (e.g., the segmenter 108), or any other computing device described herein, may divide the received plurality of representations of the content into a plurality of portions or segments of each of the plurality of representations of the content. For example, the computing device 106 may break the encoded representations of the content into segments at key frame boundaries at or near particular time periods apart or data allotments within that content. For example, the computing device 106 may divide a first audio representation of the content into a plurality of portions or segments of the first audio representation of the content and may divide a second audio representation of the content into a plurality of portions or segments of the second audio representation of the content. Similarly, the computing device 106 may divide a first video representation of the content into a plurality of portions or segments of the first video representation of the content and may divide a second video representation of the content into a plurality of portions or segments of the second video representation of the content. While the examples above describe segmenting two video representations and two audio representations of the content, this is for example purposes only as the number of representations for one or both of the encoded video and audio of the content may be greater than or less than the two in the example.

At 910, a first portion of the content at a first representation may be determined. For example, the first portion of the content at the first representation may be determined by the computing device 106 or any other computing device described herein. For example, the first portion of the content at the first representation may be determined based on the plurality of portions or segments of the first audio representation of the content. For example, the first audio representation may be associated with a first audio resolution. For example, the first audio representation may be associated with a first bitrate. For example, the first audio representation may be associated with a first CODEC. For example, the first audio representation may be associated with a first compression rate.

At 920, a first portion of the content at a second representation may be determined. For example, the first portion of the content at the second representation may be determined by the computing device 106 or any other computing device described herein. For example, the first portion of the content at the second representation may be determined based on the plurality of portions or segments of the second audio representation of the content. For example, the second representation may be different from the first representation. For example, the second audio representation may be different from the first audio representation. For example, the second audio representation may be associated with a second audio resolution. For example, the second audio resolution may be different from the first audio resolution. For example, the second audio representation may be associated with a second bitrate. For example, the second bitrate may be different from the first bitrate. For example, the second audio representation may be associated with a second CODEC. For example, the second CODEC may be different from the first CODEC. For example, the second audio representation may be associated with a second compression rate. For example, the second compression rate may be different from the first compression rate. For example, the computing device 106 may further determine a first portion of the content at a first video representation and a first portion of the content at a second video representation in substantially the same manner as described in 810 and 820 of FIG. 8.

At 930, the first portion of the content at the first representation and the first portion of the content at the second representation may be packaged for sending or transmission to a second computing device. For example, the first portion of the content at the first representation and the first portion of the content at the second representation may be packaged by the computing device 106 (e.g., the packager 110) or any other computing device described herein. For example, the second computing device may be one or more of the one or more mid-tier caches 122, the one or more edge caches 124a-c, and/or the one or more network devices 126a-c.

For example, the first portion of the content at the first representation and the first portion of the content at the second representation may be packaged in a file. For example, the file may be an AMFF file. For example, each portion of the content may be a particular time allotment of the content (e.g., two seconds of the content) or a particular amount of data of the content for each of the representations of that portion of the content. As such, the file may comprise multiple versions of the same portion of the content, each encoded according to a different audio representation and/or video representation. For example, the file may comprise multiple versions of the portion of the content encoded according to different audio representations (e.g., the first representation and the second representation) of the content. For example, a plurality of files may be generated, each file corresponding to a particular portion of a plurality of portions of the content. Each of the plurality of portions of the content may be associated with a different portion (e.g., time period, data range) of the particular content or content item. Each of the files of the plurality of files may comprises multiple versions of the same particular portion of the content (e.g., a first portion of the content, a second portion of the content, etc.) encoded according to multiple audio representations and/or video representations. The file may indicate the first portion of the content at the first representation and the first portion of the content at the second representation in a header of the file. For example, the file may indicate the first portion of the content at the first representation and the first portion of the content at the second representation in a header the same as or similar to the header 200 of FIG. 2. Similarly, if the file also includes the first portion of the content at a first video representation and the first portion of the content at a second video representation, the header of the file may also include this information in a manner the same as or similar to the header 200 of FIG. 2.

At 940, the packaged first portion of the content may be sent. For example, the packaged first portion of the content may be sent by the computing device 106 to one or more other computing device (e.g., the cache devices 122, 124a-c) via the network 120 or another network. For example, the computing device 106 may send the packaged first portion of the content to the one or more mid-tier (or remote) caches 122 via the network 120. For example, the computing device 106 may cause the one or more mid-tier caches 122 to send the packaged first portion of the content to the one or more edge caches 124a-c via the network 120 or another network based on sending the packaged first portion of the content from the computing device 106 to the one or more mid-tier caches 122 via the network 120 or another network. The packaged first portion of the content may subsequently be sent by each edge cache 124a-c to corresponding network devices 126a-c via the network 120 or another network. The packaged first portion of the content may be stored in one or more of the computing device 106 (e.g., the data storage 112), the one or more mid-tier caches 122, the one or more edge (or local) caches 124a-c, and the one or more network devices 126a-c.

While the example is described with reference to sending the packaged first portion of the content, the same process may be used to package and send all other portions (e.g., second portion, third portion, etc.) of the content (or content item) in a similar manner as described above. Each of the packaged portions (e.g., plurality of packaged portions) of the content (e.g., content item) may comprise an AMFF file. Each of the plurality of packaged portions of the content may comprise a different portion of the content and multiple versions of that portion of the content encoded according to multiple audio representations and/or video representations.

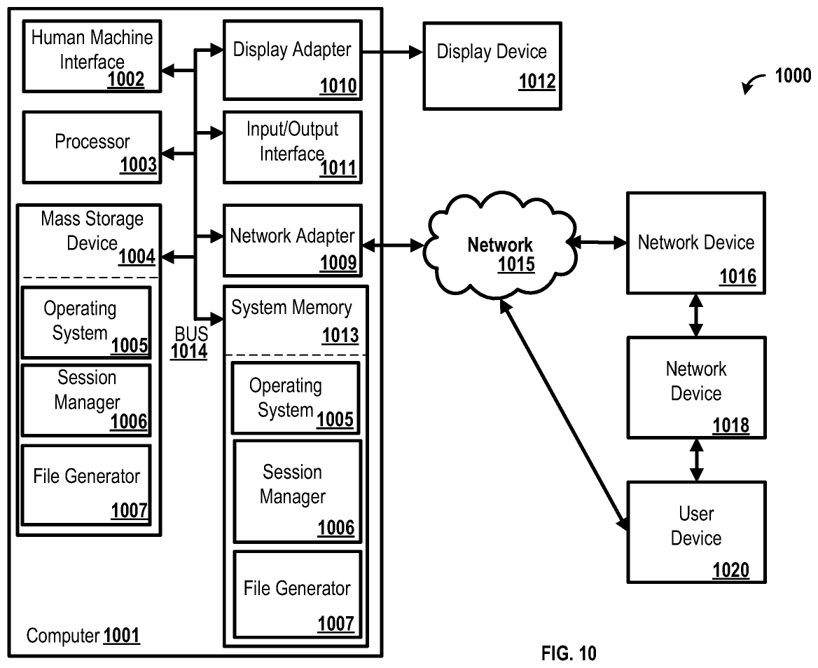

FIG. 10 shows a system 1000 comprising a computer 1001 for implementing packaging and distribution of content. Any computing device/component described herein may be the computer 1001 as shown in FIG. 10.

The computer 1001 may include one or more processors 1003, a system memory 1013, and a bus 1014 that couples various components of the computer 1001 including the one or more processors 1003 to the system memory 1013. In the case of multiple processors 1003, the computer 1001 may utilize parallel computing.

The bus 1014 may include one or more of several possible types of bus structures, such as a memory bus, memory controller, a peripheral bus, an accelerated graphics port, and a processor or local bus using any of a variety of bus architectures.

The computer 1001 may operate on and/or include a variety of computer readable media (e.g., non-transitory). Computer readable media may be any available media that is accessible by the computer 1001 and includes, non-transitory, volatile and/or non-volatile media, removable and non-removable media. The system memory 1013 has computer readable media in the form of volatile memory, such as random access memory (RAM), and/or non-volatile memory, such as read-only memory (ROM). The system memory 1013 may store data such as communication session data 1006 and/or program modules such as an operating system 1005 and file generator software 1007 that are accessible to and/or are operated on by the one or more processors 1003.

The computer 1001 may also include other removable/non-removable, volatile/non-volatile computer storage media. The mass storage device 1004 may provide non-volatile storage of computer code, computer readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1004. An operating system 1004 and file generator software 1007 may be stored on the mass storage device 1004. One or more of the operating system 1005 and file generator software 1007 (or some combination thereof) may include program modules. Communication session manager data 1006 may also be stored on the mass storage device 1004. The communication session manager data 1006 may be stored in any of one or more databases known in the art. The databases may be centralized or distributed across multiple locations within the network 1015.

A user may enter commands and information into the computer 1001 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1003 via a human machine interface 1002 that is coupled to the bus 1014, but may be connected by other interface and bus structures, such as a parallel port, game port, an IEEE 1394 Port (also known as a Firewire port), a serial port, network adapter 1009, and/or a universal serial bus (USB).

A display device 1012 may also be connected to the bus 1014 via an interface, such as a display adapter 1010. It is contemplated that the computer 1001 may have more than one display adapter 1010 and the computer 1001 may have more than one display device 1012. A display device 1012 may be a monitor, an LCD (Liquid Crystal Display), light-emitting diode (LED) display, television, smart lens, smart glass, and/or a projector. In addition to the display device 1012, other output peripheral devices may comprise components such as speakers (not shown) and a printer (not shown) which may be connected to the computer 1001 via Input/Output Interface 1011. Any step and/or result of the methods may be output (or caused to be output) in any form to an output device. Such output may be any form of visual representation, including, but not limited to, textual, graphical, animation, audio, tactile, and the like. The display device 1012 and computer 1001 may be part of one device, or separate devices.

The computer 1001 may operate in a networked environment using logical connections to one or more remote computing devices, such as network devices 1016 and 1018 and user device 1020. Each of the network devices 1016 and 1018 may be a server, a router, a network computer, a cache device, a peer device, an edge device, other common network node, and so on. The user device 1020 may be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, and so on. Logical connections between the computer 1001 and the network devices 1016 and 1018 and/or user device 1020 may be made via a network 1015, such as a local area network (LAN) and/or a general wide area network (WAN). Such network connections may be through a network adapter 1009. A network adapter 1009 may be implemented in both wired and wireless environments. Such networking environments are conventional and commonplace in dwellings, offices, enterprise-wide computer networks, intranets, and the Internet.

Application programs and other executable program components such as the operating system 1005 are shown herein as discrete blocks, although it is recognized that such programs and components may reside at various times in different storage components of the computing device 1001, and are executed by the one or more processors 1003 of the computer 1001. An implementation of file generator software 1006 may be stored on or sent across some form of computer readable media. Any of the disclosed methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a computing device and from a user device, in a communication session, a request for a first portion of content at a first representation, wherein the first representation is associated with a first video resolution;
sending, to the user device, the first portion of the content at the first representation;
receiving, by the computing device and from the user device, in the communication session, a second request for a second portion of the content at a second representation, wherein the second representation is associated with a second video resolution different from the first video resolution; and
sending, to the user device, in the communication session, the second portion of the content at the second representation, wherein the computing device comprises the first representation of the content and the second representation of the content.

2. The method of claim 1, further comprising:
receiving, from the user device, a request to initiate the communication session; and
initiating the communication session with the user device.

3. The method of claim 1, wherein the first portion of the content comprises a segment of the content.

4. The method of claim 1, further comprising:
receiving, by the computing device, a file comprising the first portion of the content at a plurality of representations comprising the first representation; and
generating, based on the file, a second file comprising the first portion of the content at the first representation, wherein sending the first portion of the content comprises sending, to the user device, the file.

5. The method of claim 1, wherein the first representation is associated with a first bit rate, wherein the second representation is associated with a second bit rate, and wherein the first bit rate is different than the second bit rate.

6. The method of claim 1, wherein the request for the first portion of content further comprises a request for the first portion of the content at a third representation associated with a first audio resolution, wherein the second request for the second portion of the content further comprises a request for the second portion of the content at a fourth representation associated with a second audio resolution different from the first audio resolution, wherein sending the first portion of the content further comprises sending the first portion of the content at the first representation and the third representation, and wherein sending the second portion of the content further comprises sending the second portion of the content at the second representation and the fourth representation.

7. The method of claim 1, wherein the first video resolution comprises at least one of 480p, 576p, 720p, 1080p, 1440p, 4K, or 8K.

8. The method of claim 1, wherein the communication session an uninterrupted communication session between the computing device and the user device.

9. A method comprising:
receiving, by a computing device and from a user device, in a communication session, a request for a first portion of content at a first representation, wherein the first representation is associated with a first audio resolution;
sending, to the user device, the first portion of the content at the first representation;
receiving, by the computing device and from the user device, in the communication session, a second request for a second portion of the content at a second representation, wherein the second representation is associated with a second audio resolution different from the first audio resolution; and
sending, to the user device, in the communication session, the second portion of the content at the second representation.

10. The method of claim 9, further comprising:
receiving, from the user device, a request to initiate the communication session; and
initiating the communication session with the user device.

11. The method of claim 9, wherein the first portion of the content comprises a segment of the content.

12. The method of claim 9, further comprising:
receiving, by the computing device, a file comprising the first portion of the content at a plurality of representations comprising the first representation; and
generating, based on the file, a second file comprising the first portion of the content at the first representation, wherein sending the first portion of the content comprises sending, to the user device, the file.

13. The method of claim 9, wherein the first representation is associated with a first bit rate, wherein the second representation is associated with a second bit rate, and wherein the first bit rate is different than the second bit rate.

14. The method of claim 9, wherein the request for the first portion of content further comprises a request for the first portion of the content at a third representation associated with a first video resolution, wherein the second request for the second portion of the content further comprises a request for the second portion of the content at a fourth representation associated with a second video resolution different from the first video resolution, wherein sending the first portion of the content further comprises sending the first portion of the content at the first representation and the third representation, and wherein sending the second portion of the content further comprises sending the second portion of the content at the second representation and the fourth representation.

15. The method of claim 14, wherein the first video resolution comprises at least one of 480p, 576p, 720p, 1080p, 1440p, 4K, or 8K.

16. The method of claim 9, wherein the communication session an uninterrupted communication session between the computing device and the user device.

17. A method comprising:
determining, by a computing device, a plurality of representations for content;
receiving the content encoded according to the plurality of representations;
generating a file comprising a plurality of first portions of the content encoded according to the plurality of representations; and
sending, to a second computing device, the file comprising, the plurality of the first portions of the content encoded according to the plurality of representations.

18. The method of claim 17, wherein the plurality of representations comprise a first representation associated with first video resolution and a second representation associated with a second video resolution different from the first video resolution.

19. The method of claim 17, wherein the plurality of representations comprise a first representation associated with a first audio resolution and a second representation associated with a second audio resolution different from the first audio resolution.

20. The method of claim 17, further comprising generating a header for the file, wherein the header comprises at least one of: an indication of a first representations of the first portion of the content in the file, a quantity of bytes associated with a first representation of the plurality of representations of the first portion of the content, or a run length for the first representation of the plurality of representations of the first portion of the content.
